(19) United States
(12) Patent Application Publication
(10) Pub. No.: US 2023/0319857 A1
(43) Pub. Date: Oct. 5, 2023

(54) METHOD AND APPARATUS FOR SIDELINK POSITIONING

(71) Applicant: Samsung Electronics Co., Ltd., Gyeonggi-do (KR)

(72) Inventors: Yuhan ZHOU, San Diego, CA (US); Philippe Jean Marc Michel SARTORI, Naperville, IL (US); Yaser Mohamed Mostafa Kamal FOUAD, San Diego, CA (US)

(21) Appl. No.: 18/113,456

(22) Filed: Feb. 23, 2023

Related U.S. Application Data
(60) Provisional application No. 63/325,919, filed on Mar. 31, 2022.
(60) Provisional application No. 63/342,476, filed on May 16, 2022.

(51) Int. Cl. H04W 72/40; H04W 72/0446; H04W 72/25

(52) U.S. Cl. CPC H04W 72/40; H04W 72/0446; H04W 72/25

(57) ABSTRACT

Methods and apparatuses are provided in which a user equipment (UE) determines a resource pool for reception of a sidelink (SL)-positioning reference signal (PRS). The UE receives a slot and determines whether the slot includes resources in the resource pool for the SL-PRS. The UE decodes SL control information (SCI) of the slot using a first format for the SL-PRS, in case that the slot includes the resources in the resource pool.

### CROSS-REFERENCE TO RELATED APPLICATIONS

This application claims the priority benefit under 35 U.S.C. § 119(e) of U.S. Provisional Application Nos. 63/325,919 and 63/342,476, filed on Mar. 31, 2022, and May 16, 2022, respectively, the disclosures of which are incorporated by reference in their entirety as if fully set forth herein.

### TECHNICAL FIELD

The disclosure generally relates to sidelink (SL) positioning. More particularly, the subject matter disclosed herein relates to signal design for performing SL positioning.

### SUMMARY

In 3^{rd} Generation Partnership Project (3GPP) Release (Rep-16/17, positioning for a new radio (NR) link between a universal mobile telecommunications system (UMTS) terrestrial radio access network (UTRAN) and a user equipment (UE) (i.e., an NR Uu link) was standardized for the cellular link. In 3GPP Rel-18, positioning protocols are extended for the SL. A protocol to perform SL positioning differs from a cellular protocol due to the absence of a central controller on the SL.

To solve this problem, the UE should determine when to send reference signals (RSs) for positioning, where to obtain the various configurations for positioning, and where to report positioning information. Since resource allocation is distributed (e.g., there is no central controller), mechanisms are needed to limit/avoid collisions.

One issue with the above approach is that there is no RS designed in SL for positioning, and positioning reference signals (PRSs) must be modified in the Uu link to fit SL communication. Reusing an existing RS in SL, such as, for example, channel state information (CSI)-RS is not desirable because the PRS requires a large bandwidth and due to UE multiplexing.

To overcome these issues, solutions are provided for development of an SL-PRS in a frequency/time domain pattern, and a UE procedure for transmitting and receiving the SL-PRS.

The above approaches improve on previous methods because they focus on ensuring that positioning overhead is low in order to be deployed at scale, ensuring there is low latency.

In an embodiment, a method is provided in which a UE determines a resource pool for reception of an SL-PRS. The UE receives a slot and determines whether the slot includes resources in the resource pool for the SL-PRS. The UE decodes SL control information (SCI) of the slot using a first format for the SL-PRS, in case that the slot includes the resources in the resource pool.

In an embodiment, a method is provided in which a UE determines a resource pool for reception of an SL-PRS, and receives a positioning slot including resources in the resource pool. The positioning slot includes first resources of one or more symbols for a physical SL control channel (PSCCH) spanning first subcarriers of the positioning slot. The positioning slot also includes second resources for the SL-PRS in a zone of the positioning slot that corresponds to physical SL shared channel (PSSCH) resources in a non-positioning slot. The second resources span a bandwidth of the positioning slot.

In an embodiment, a UE is provided that includes a processor and a non-transitory computer readable storage medium storing instructions. When executed, the instructions cause the processor to determine a resource pool for an SL-PRS, receive a slot, and determine whether the slot includes resources in the resource pool for the SL-PRS. The instructions also cause the processor to decode SCI of the slot using a first format for the SL-PRS, in case that the slot includes the resources in the resource pool.

### BRIEF DESCRIPTION OF THE DRAWINGS

In the following section, the aspects of the subject matter disclosed herein will be described with reference to exemplary embodiments illustrated in the figures, in which:

FIG. 1 is a diagram illustrating a communication system, according to an embodiment;

FIG. 2 is a diagram illustrating downlink (DL) PRS resources, according to an embodiment;

FIG. 3 is a diagram illustrating a slot format with feedback, according to an embodiment;

FIG. 4 is a diagram illustrating a slot format without feedback, according to an embodiment;

FIG. 5 is a flowchart illustrating a method for resource selection, according to an embodiment;

FIG. 6 is a diagram illustrating comb indexing on a first symbol for comb-4, according to an embodiment;

FIG. 7 is a diagram illustrating an RS resource pool when an entire carrier bandwidth is used, according to an embodiment;

FIG. 8 is a diagram illustrating a slot structure in the RS resource pool, according to an embodiment;

FIG. 9 is a diagram illustrating a slot structure in the RS resource pool, according to another embodiment;

FIG. 10 is a diagram illustrating an alternate SL-PRS location in a slot structure with two UEs, according to an embodiment;

FIG. 11 is a diagram illustrating an alternate SL-PRS location in a slot structure with a single UE, according to an embodiment;

FIG. 12 is a flowchart illustrating a method for receiving the SL-PRS, according to an embodiment;

FIG. 13 is a flowchart illustrating method for receiving the SL-PRS, according to an embodiment;

FIG. 14 is a flowchart illustrating a method for transmitting the SL-PRS, according to an embodiment;

FIG. 15 is a flowchart illustrating a method for resource selection in SL positioning, according to an embodiment;

FIG. 16 is a diagram illustrating an AGC for a slot of the SL-PRS, according to an embodiment;

FIG. 17 is a diagram illustrating an AGC in a slot structure, according to an embodiment;

FIG. 18A is a diagram illustrating a slot structure with PSCCH repetition, according to an embodiment;

FIG. 18B is a diagram illustrating a slot structure with SL-PRS repetition, according to an embodiment;

FIG. 19 is a diagram illustrating a slot structure for the SL-PRS with multiple PSCCH repetition, according to an embodiment;

FIG. 20 is a diagram illustrating a slot structure for the SL-PRS with PSCCH interlacing, according to an embodiment;

FIG. 21 is a diagram illustrating a slot structure for the SL-PRS with PSCCH interlacing and repetition, according to an embodiment;

FIG. 22 is a diagram illustrating a slot structure for the SL-PRS without SCI, according to an embodiment;

FIG. 23 is a diagram illustrating a method for reception of the SL-PRS multiplexed with data, according to an embodiment; and

FIG. 24 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and-is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

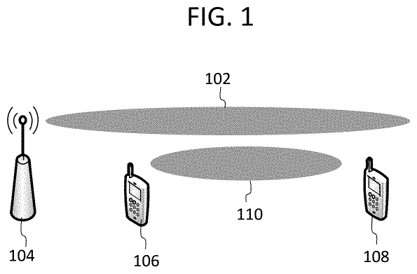

FIG. 1 is a diagram illustrating a communication system, according to an embodiment. In the architecture illustrated in FIG. 1, a control path 102 may enable the transmission of control information through a network established between a base station or a gNode B (gNB) 104, a first UE 106, and a second UE 108. A data path 110 may enable the transmission of data (and some control information) on an SL between the first UE 106 and the second UE 108. The control path 102 and the data path 110 may be on the same frequency or may be on different frequencies.

The Rel-16 design of a PRS may be reused for SL positioning. Specifically, the sequences for PRSs may be generated by gold sequences and mapped to quadrature phase-shift keying (QPSK) constellation points, and at least 4096 different sequence identifiers (IDs) may be supported. Further, a resource element (RE) pattern of downlink DL PRS may follow the comb-structure with a larger number of different densities (e.g., 1, 2, 3, 4, 6, or 12) per physical resource block (PRB). The bandwidth of a PRS ay be configurable. A staggered RE pattern over time and frequency may be used to achieve an effective comb-1 structure at a receiver (e.g., a UE).

A PRS sequence r(m) as the QPSK symbol may be written as Equation (1) below:

$$r ( m ) = \frac{1}{\sqrt{2}} ( 1 - 2 c ( 2 m ) ) + j \frac{1}{\sqrt{2}} ( 1 - 2 c ( 2 m + 1 ) ) \qquad ( 1 )$$

where the pseudo-random sequence c(i) is a length-31 gold sequence. The output sequence c(n) of length M_{PN}, where n=0,1, . . . , M_{PN}−1, may be defined by Equation (2) below:

c(n)=(x₁(n+N_{C})+x₂(n+N_{C}))mod2

x₁(n+31)=(x₁(n+3)+x₁(n))mod2

x₂(n+31)=(x₂(n+3)+x₂(n+2)+x₂(n+1)+x₂(n))mod2 (2)

where N_{C}=1600 and a first m-sequence x₁(n) may be initialized with x₁(0)=1, x₁(n)=0, n=1,2, . . . ,30. The initialization of a second m-sequence, x₂(n) may be denoted by cᵢₙᵢₜ=Σᵢ₌₀³⁰x₂(k)·2ⁱ, which is generated by Equation (3) below:

$${c}_{i n i t} = ( {2}^{22} ⌊ \frac{{n}_{ID , seq}^{P R S}}{1024} ⌋ + {2}^{10} ( {N}_{s y m b}^{slot} {n}_{s , f}^{μ} + l + 1 ) ( 2 ( {n}_{ID , seq}^{P R S} mod 1024 ) + 1 ) + ( {n}_{ID , seq}^{P R S} mod 1024 ) ) mod {2}^{31} \qquad ( 3 )$$

where n_{s,f}^{μ} is the slot number, a DL PRS sequence ID n_{ID,seq}^{PRS}∈{0,1, . . . ,4095} is given by the higher-layer parameter, and l is an orthogonal frequency division multiplexing (OFDM) symbol within the slot to which the sequence is mapped.

For each DL PRS resource configured, the UE may assume the sequence r(m) is scaled with a factor β_{PRS} and mapped to resources elements (k, l)_{p,μ} according to Equation (4) below, when conditions are fulfilled:

α_{k,l}^{(p,μ)}=β_{PRS}r(m)

m=0, 1, . . .

k=mK_{comb}^{PRS}+((k_{offset}^{PRS}+k′)modK_{comb}^{PRS})

l=lₛₜₐᵣₜ^{PRS}, lₛₜₐᵣₜ^{PRS}+1, . . ., lₛₜₐᵣₜ^{PRS}+L_{PRS}−1, (4)

As a first condition, the RE (k, l)_{p,μ} is within the resource blocks occupied by the DL PRS resource for which the UE is configured. As a second condition, the symbol l is not used by any synchronization signal (SS) and physical broadcast channel (SS/PBCH) block used by the serving cell for a DL PRS transmitted from the serving cell or indicated by the higher-layer parameter for a DL PRS transmitted from a non-serving cell. As a third condition, a DL PRS is transmitted in some specific slots that are indicated by high-layer parameters. Further, lₛₜₐᵣₜ^{PRS} is the first symbol of the DL PRS within a slot and given by the higher-layer parameter. The size of the DL PRS resource in the time domain L_{PRS}∈{2,4,6,12} is given by the higher-layer parameter. The comb size K_{comb}^{PRS}∈{2,4,6,12} is given by the higher-layer parameter. The resource-element offset k_{offset}^{PRS}∈{0,1, . . . ,K_{comb}^{PRS}−1} is given by the higher-layer parameter. The quantity k′ is given by Table 1 showing the frequency offset k′ as a function of l−lₛₜₐᵣₜ^{PRS}.

The reference point for k=0 is the location of point A of the positioning frequency layer, in which the DL PRS resource is configured where point A is given by the higher-layer parameter.

TABLE 1

| | Symbol number within the DL PRS resource l − lₛₜₐᵣₜ^{PRS} | | | | | | | | | | | |
|---|---|---|---|---|---|---|---|---|---|---|---|---|
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

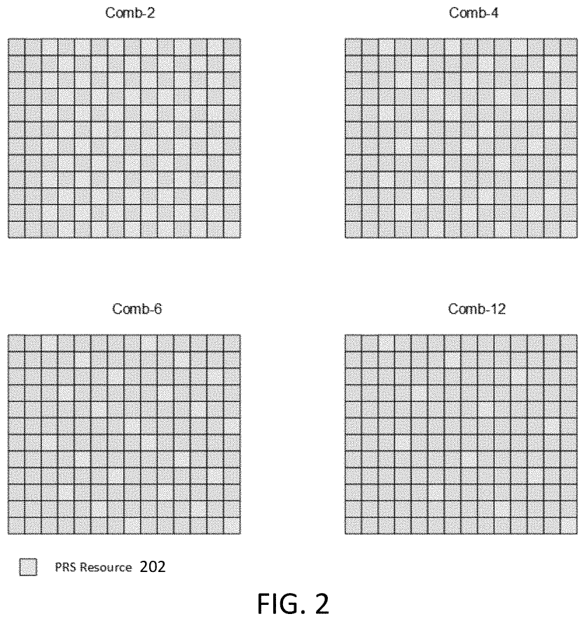

FIG. 2 is a diagram illustrating DL PRS resource allocation for K_{comb}^{PRS}=2, 4, 6, 12, according to an embodiment. Specifically, PRS resources 202 are shown in each of K_{comb}^{PRS}=2, K_{comb}^{PRS}=4, K_{comb}^{PRS}=6, and K_{comb}^{PRS}=12, when L_{PRS}=12 and lₛₜₐᵣₜ^{PRS}=2.

An SL physical channel corresponds to a set of REs carrying information originating from higher layers. A PSSCH may carry second stage SCI and an SL data payload. A physical SL broadcast channel (PSBCH) may be equivalent to a physical broadcast channel (PBCH) in a Uu link. A PSCCH may carry first stage SCI. A physical SL feedback channel (PSFCH) may carry 1-bit hybrid automatic repeat request (HARQ)-acknowledgement (ACK) feedback.

An SL physical signal corresponds to a set of REs used by the physical layer, but does not carry information originating from higher layers. Demodulation reference signals (DM-RSs) are SL signals for PSCCH, PSSCH, and PSBCH. A CSI-RS may be for CSI measurement on an SL. Phase-tracking reference signals (PT-RSs) may be for frequency range 2 (FR2) phase noise compensation. An SL primary synchronization signal (S-PSS) may be for synchronization on the SL. An SL secondary synchronization signal (S-SSS) may be for synchronization on the SL.

In NR SL, a self-contained approach may be considered, whereby each slot contains control, data, and in some cases feedback. A regular NR SL slot consists of 14 OFDM symbols. However, the SL may also be configured/pre-configured to occupy less than 14 symbols in a slot.

SCI in NR vehicle to everything (V2X) may be transmitted in two stages. The first stage SCI (i.e., SCI format 1-A) carried on the PSCCH may contain information enabling sensing operations, as well as the resource allocation field for the scheduling of PSSCH and second stage SCI. The second stage SCI (i.e., SCI format 2-A or SCI format 2-B) may be transmitted in PSSCH resources and may be associated with the PSSCH DMRS, which contains information for decoding the PSSCH.

The PSCCH and PSSCH may be multiplexed in time and frequency within the same slot. Depending on whether or not feedback is configured for a given slot, there may be different slot formats.

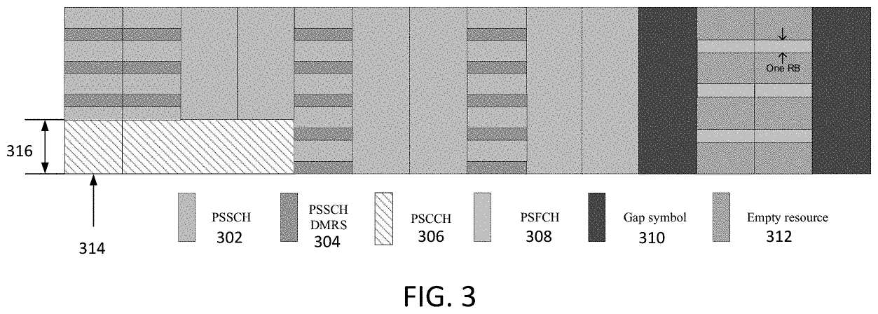

FIG. 3 is a diagram illustrating a slot structure with feedback resources, according to an embodiment. The slot structure is shown with PSSCH 302, PSSCH DMRS 304, PSCCH 306, PSFCH 308, gap symbol 310, and empty resources 312. A first symbol 314 in a subchannel 316 is a copy of a second symbol.

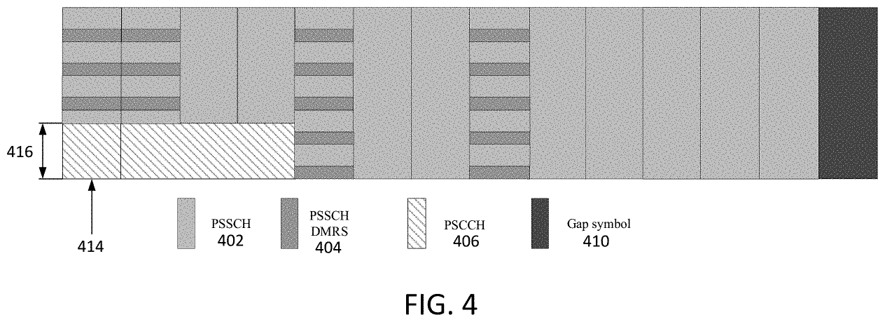

FIG. 4 is a diagram illustrating a slot structure without feedback resources, according to an embodiment. The slot structure is shown with PSSCH 402, PSSCH DMRS 404, PSCCH 406, and gap symbol 410. A first symbol 414 in a subchannel 416 is a copy of a second symbol.

For both slot structures, the first symbol 314 and 414 may be repeated for automatic gain control (AGC), and the last symbol of the slot may be left as a gap for transmit (Tx)/receive (Rx) switching. First stage SCI may be carried in the PSCCH 306 and 406 with 2 or 3 symbols with SCI format 1-A. The number of PSCCH symbols may be explicitly configured/pre-configured per Tx/Rx resource pool by a higher layer parameter sl-TimeResourcePSCCH. A lowest RB of a PSCCH is the same as a lowest RB of the corresponding PSSCH. In the frequency domain, the number of RBs in PSCCH may be pre-configured, and is not greater than the size of one sub-channel. Herein, if a UE is using multiple consecutive subchannels for SL transmission within a slot, the PSCCH may only exist in the first subchannel.

The SL transport channel, which carries the transport blocks (TBs) of data for transmission over the SL, and the second stage SCI may be carried over the PSSCH. The resources in which the PSSCH is transmitted may be scheduled or configured by a gNB (i.e., Mode-1) or determined through a sensing procedure conducted autonomously by the transmission (i.e., Mode-2).

The feedback (as shown in FIG. 3) may be carried over the PSFCH 308. This channel may be used to transmit the feedback information from the Rx to the Tx UEs. It may be used for unicast and groupcast options 2/1. In case of unicast and groupcast option 2, the PSFCH may be used to transmit ACK/Non-acknowledgement (ACK/NACK), whereas for the case of groupcast option 1, the PSFCH may carry only NACK. For SL feedback, a sequence-based PSFCH format (PSFCH format 0) with one symbol (not including the AGC training period) may be supported. In PSFCH format 0, the ACK/NACK bit is transmitted through two Zadoff-Chu (ZC) sequences of length 12 (same root but different cyclic shift), whereby the presence of one sequence indicates an ACK and the presence of the other indicates a NACK (i.e., these sequences are used in a mutually exclusive manner).

In the UE procedure for determining the PSSCH resources in SL resource allocation Mode-2, the higher layer may request the UE to determine a subset of resources from which the higher layer will select resources for PSSCH/PSCCH transmission. To trigger this procedure, in slot n, the higher layer may provide the parameters for the PSSCH/PSCCH transmission. The parameters may include the resource pool from which the resources are to be reported, L1 priority, prio_{TX}, the remaining packet delay budget, the number of sub-channels to be used for the PSSCH/PSCCH transmission in a slot, L_{subCH}, and optionally, the resource reservation interval, P_{rsvp_TX}, in units of ms.

Higher layer parameters that affect this procedure may include sl-SelectionWindowList. Internal parameter T₂ₘᵢₙ may be set to the corresponding value from higher layer parameter sl-SelectionWindowList for a given value of prio_{TX}.

Another parameter that may affect this procedure is sl-Thres-RSRP-List. This higher layer parameter provides a reference signal receive power (RSRP) threshold for each combination (pᵢ, pⱼ), where pᵢ is the value of the priority field in a received SCI format 1-A, and pᵢ is the priority of the transmission of the UE selecting resources. For a given invocation of this procedure, pⱼ=prio_{TX}.

Additional higher layer parameters that may affect this procedure include sl-RS-ForSensing, which selects if the UE uses the PSSCH-RSRP or PSCCH-RSRP measurement, sl-ResourceReservePeriodList, and sl-Sensing Window. Internal parameter T₀ may be defined as the number of slots corresponding to sl-Sensing Window.

Further higher layer parameters that may affect this procedure include sl-TxPercentageList. Internal parameter X for a given prioTx may be defined as sl-TxPercentageList (prio_{TX}) converted from percentage to ratio. Finally, the parameters may include sl-PreemptionEnable, which if provided, and not equal to “enabled”, internal parameter priopre may be set to the higher layer provided parameter sl-PreemptionEnable.

The resource reservation interval, P_{rsvp_TX}, if provided, may be converted from units of ms to units of logical slots, resulting in P′_{rsvp_TX}. (t₀^{SL}, t₁^{SL}, t₂^{SL}, . . . ) denotes the set of slots which may belong to an SL resource pool.

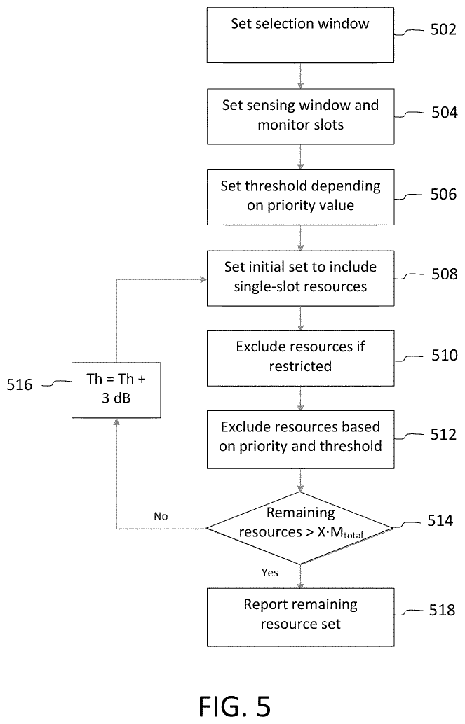

FIG. 5 is a diagram illustrating a method for Mode-2 resource selection, according to an embodiment. At 502, a selection window may be set. A candidate single-slot resource for transmission R_{x, y} may be defined as a set of L_{subCH} contiguous sub-channels with sub-channel x+j in slot t_{y}^{SL}, where j=0, . . . , L_{subCH}−1. The UE may assume that any set of L_{subCH} contiguous sub-channels included in the corresponding resource pool within the time interval [n+T₁, n+T₂] correspond to one candidate single-slot resource, where selection of T₁ is up to UE implementation under 0≤T₁≤T_{proc,1}, and where T_{proc,1} is defined in slots. If T₂ₘᵢₙ is shorter than the remaining packet delay budget (in slots) then T₂ is up to UE implementation subject to T₂ₘᵢₙ≤T₂≤remaining packet budget (in slots). Otherwise, T₂ is set to the remaining packet delay budget (in slots). The total number of candidate single-slot resources is denoted by Mₜₒₜₐₗ.

At 504, a sensing window may be set and slots may be monitored by decoding PSCCH and measuring RSRP. The sensing window may be defined by the range of slots [n−T₀, n−T_{proc,0}), where T₀ is defined above and T_{proc,0} is defined in slots. The UE may monitor slots that can belong to an SL resource pool within the sensing window, except for those in which its own transmissions occur. The UE may perform the subsequent steps based on the decoded PSCCH and the measured RSRP in these slots.

At 506, a threshold may be set depending on the priority value. An internal parameter Th(pᵢ, pⱼ) may be set to the corresponding value of RSRP threshold indicated by the i-th field in sl-Thres-RSRP-List, where i=pᵢ+(pⱼ−1)*8.

At 508, an initial set S_{A} may be initialized to include all of the candidate single-slot resources.

At 510, the UE may exclude resources if restricted. Specifically, the UE may exclude any candidate single-slot resource R_{x,y} from the set S_{A} if it meets all the following conditions. First, the UE has not monitored the slot tₘ^{SL} at 504. Second, for any periodicity value allowed by the higher layer parameter reservationPeriodAllowed and a hypothetical SCI format 0-1 received in slot tₘ^{SL} with “Resource reservation period” field set to that periodicity value and indicating all subchannels of the resource pool in this slot, the third condition of 512 may be met.

At 512, the UE may exclude resources if they are occupied by the UE with higher priority and RSRP>Th. Specifically, the UE may exclude any candidate single-slot resource R_{x,y} from the set S_{A} if it meets all of the following conditions. First, the UE receives an SCI format 0-1 in slot tₘ^{SL}, and a “resource reservation period” field, if present, and a “Priority” field in the received SCI format 0-1 indicate the values P_{rsvp_RX} and prio_{RX}, respecitvely. Second, the RSRP measurement performed, according to received SCI format 0-1, is higher than Th(prio_{RX}). Third, the SCI format received in slot tₘ^{SL} or the same SCI format which, if and only if the “resource reservation period” field is present in the received SCI format 0-1, is assumed to be received in slot(s) t_{m+q×P′}_{_{rsvp_RS}}^{SL}, determines the set of resource blocks and slots that overlap with R_{s,y+j×P′}_{_{rsvp_TX}} for q=1, 2, . . . , Q and j=0, 1, . . . , Cᵣₑₛₑₗ−1. Here, P′_{rsvp_RX} is P_{rsvp_RX} converted to units of logical slots,

$$Q = ⌈ \frac{{T}_{s c a l}}{{P}_{r s ν {p}_{-} RX}} ⌉$$

if P_{rsvp_RX}<T_{scal} and n′−m≤P′_{rsvp_RX}, where t_{n′}^{SL}=n if slot n belongs to the set(t₀^{SL}, t₁^{SL}, . . . , t_{Tmax}^{SL}), otherwise slot t_{n′}^{SL} is the first slot after slot n belonging to the set(t₀^{SL}, t₁^{SL}, . . . , t_{Tmax}^{SL}); otherwise Q=1. T_{scal} is set to selection window size T₂ converted to units of msec.

At 514, the UE determines whether remaining resources in the selection window are greater than X·Mₜₒₜₐₗ.

If the number of candidate single-slot resources remaining in the set S_{A} is less than or equal to X·Mₜₒₜₐₗ, then Th(pᵢ, pⱼ) may be increased by 3 dB for each priority value Th(pᵢ, pⱼ), at 516, before returning to set the initial set at 508.

If the number of candidate single-shot resources remaining in the set S_{A} is greater than X·Mₜₒₜₐₗ, then the UE may report remaining resources of set S_{A} to higher layers, at 518, and the higher layers may randomly select a candidate resource for transmission.

General characteristics may be provided for PRS design, which may guide how to design the PRS transmission for the SL.

Unlike the Uu link where the PRS is transmitted periodically, the transmission of a PRS on the SL may be periodic, semi-persistent, and aperiodic. The PRS may be configured by a location management function (LMF), and the semi-persistent and aperiodic PRS signals may be triggered by SCI or medium access control (MAC) control element (CE) carried by PSSCH. In 3GPP Rel-17, the CSI request is included in second stage SCI (i.e., SCI format 2-A). Therefore, the triggering of semi-persistent and/or aperiodic PRS may also be included in the second stage SCI. A similar PRS structure may be needed for the SL.

Similar to Uu positioning, the parameters of PRS, such as, for example, the resource allocation in the time and frequency domains for SL positioning, may be configured/pre-configured by the LMF. The UE may expect that it will be configured with SL-PRS IDs, each of which may be defined such that it is associated with multiple SL-PRS resource sets. The UE may expect that one of these SL-PRS IDs, along with an sl-PRS-ResourceSetID and an sl-PRS-ResourceID, may be used to uniquely identify a DL PRS resource. For periodic PRS transmission, the UE may need to detect the SL-PRS ID information itself. For semi-persistent and aperiodic PRS transmission, the SL-PRS ID may be included in SCI (e.g., second stage SCI) or a MAC CE.

When the triggering signal for semi-persistent and aperiodic PRS are carried in SCI, the following cases may exist. If the triggering information is included in first stage SCI, the reserved bits may be used and the number of bits may be pre-configured. If the triggering information is included in second stage SCI, the extra bit (1 bit or 2 bits) may be added into a current SCI format 2-A and/or SCI format 2-B.

Accordingly, the UE may be configured to transmit a periodic/semi-persistent/aperiodic PRS. The UE may be configured by the network with a Tx UE ID (i.e., the source ID) associated with an SL-PRS-ID. For semi-persistent/aperiodic PRS transmission, the SL-PRS-ID may be included in SCI or a MAC CE.

The bandwidth of the PRS may also be considered for SL positioning. Generally, the accuracy of positioning may be proportional to the bandwidth of the RSs for positioning. In 3GPP Rel-16, an SL resource pool may consist of sl-NumSubchannel contiguous sub-channels and a sub-channel may consist of sl-SubchannelSize contiguous PRBs, where sl-NumSubchannel may be {1, 2 . . . 26, 27} and sl-SubchannelSize may be {10, 12, 15, 20, 25, 50, 75, 100}. It may be beneficial to have a PRS design that is not based on the existing subchannel structure, but instead, to define PRS signals that can cover the maximum available bandwidth.

Accordingly, for resource allocation Mode-2 in SL positioning, the allocated PRS and/or CSI-RS resources may cover all of the maximum available bandwidth for the high accuracy requirement in timing based positioning methods, including, for example, time difference on arrival (TDOA) and round trip time (RTT).

The maximum bandwidth of PRS may also be constrained by the operation band. NR V2X is designed to operate in the operating bands in FR1, as defined in Table 2.

TABLE 2

| | Sidelink (SL) | Sidelink (SL) | | |
|---|---|---|---|---|
| V2X | Transmission | Reception | | |
| Operating | operating band | operating band | Duplex | |
| Band | F_{UL}_{_{—}}_{low}-F_{UL}_{_{—}}_{high} | F_{DL}_{_{—}}_{low}-F_{DL}_{_{—}}_{high} | Mode | Interface |
| n38¹ | 2570 MHz-2620 MHz | 2570 MHz-2620 MHz | HD | PC5 |
| n47 | 5855 MHz-5925 MHz | 5855 MHz-5925 MHz | HD | PC5 |

Note 1:
When this band is used for V2X SL service, the band is exclusively used for NR V2X in particular regions.

As shown, the maximum bandwidth for PRS is 50 MHz in band n38, and 70 MHz in band n47. There are many cases in which more bandwidth is needed to increase the accuracy. As a first possibility, the PRS may be transmitted in unlicensed spectrum, where more bandwidth is available. As a second possibility, carrier aggregation may be used (between multiple licensed carriers, multiple unlicensed carriers, or a combination thereof).

Accordingly, the UE may be configured to transmit the PRS on both licensed and unlicensed bands for SL positioning. Transmission of PRS signals with carrier aggregation may be supported for SL positioning.

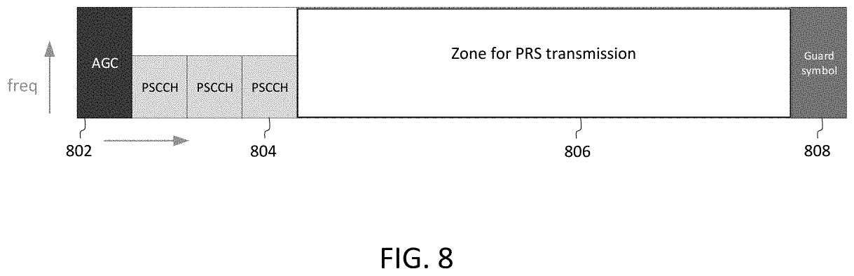

An SL-PRS may be designed by reusing the general principal described above, as well as the principles for the cellular PRS. In particular, a PRS may be defined as a comb. FIG. 8 is a diagram illustrating a slot structure in an RS resource pool, according to an embodiment. Reusing this the general design, SL-PRS may be defined with parameters of the starting symbol in the slot, the finishing symbol in the slot, a comb factor (as shown in FIG. 8, a comb-N means that one every Nth RE is used), and an offset factor. The offset factor may be defined as the first RE occupied in frequency in the first symbol where the PRS is transmitted.

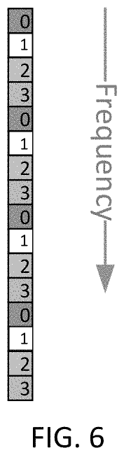

FIG. 6 is a diagram is a diagram illustrating comb indexing on a first symbol for comb-4, according to embodiment. Specifically, for comb-4, four combs are defined with indexes 0, 1, 2, 3.

Some of the parameters defining an SL-PRS may be implicit. The starting symbol may be the first symbol available (e.g., immediately after the PSCCH). The end symbol may be the last symbol available. The same comb factor may be used for all SL-PRSs.

The PRS may be designed as a comb, but other structures may also be used, as long as a relatively uniform mapping in frequency may be obtained, and a systematic indexing/multiplexing of SL-PRSs over one slot may be achieved.

One way to generate an SL-PRS is to use the CSI-RS. In SL communications, the Tx UE may configure aperiodic SL CSI reporting from the Rx UE through the PSSCH transmission. CSI-RS may be transmitted by a UE, only if channel quality indicator (CQI)/rank indicator (RI) reporting is enabled by higher layer signaling and the corresponding SCI by the UE triggers the SL CQI/RI reporting. The CSI-RS in SL may also be used for positioning purposes. Specifically, to apply CSI-RS for SL positioning, specific configurations are selected. First, Density=1 with contiguous frequency allocation. Second, code division multiplexing (CDM)-Type=noCDM. Third, from Table 3 below, showing CSI-RS locations within a slot, only row 1 with comb-4 and row 2 with comb-12 are used.

A new signaling may be needed to indicate whether the CSI-RS is for a positioning purpose or for legacy usage. Signaling may be defined by adding a radio resource control (RRC) field (e.g., in the SL CSI-RS configuration).

TABLE 3
Tab

| | Ports | Density | | | CDM group | | |
|---|---|---|---|---|---|---|---|
| Row | X | ρ | cdm-Type | (k̅, l̅) | index j | k′ | l′ |
| 1 | 1 | 3 | noCDM | (k₀, l₀), (k₀ + 4, l₀), (k₀ + 8, l₀) | 0, 0, 0 | 0 | 0 |
| 2 | 1 | 1, 0.5 | noCDM | (k₀, l₀), | 0 | 0 | 0 |
| 3 | 2 | 1, 0.5 | fd-CDM2 | (k₀, l₀), | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), (k₃, l₀) | 0, 1, 2, 3 | 0, 1 | 0 |
| 7 | 8 | 1 | fd-CDM2 | (k₀, l₀), (k₁, l₀), (k₂, l₀ + 1), | 0, 1, 2, 3 | 0, 1 | 0 |
| | | | | (k₁, l₀ + 1) | | | |
| 8 | 8 | 1 | cdm4- | (k₀, l₀), (k₁, l₀) | 0, 1 | 0, 1 | 0, 1 |
| | | | FD2-TD2 | | | | |
| 9 | 12 | 1 | fd-CDM2 | (k₀, l₀), (k₁, l₀), (k₂, l₀), | 0, 1, 2, 3, 4, 5 | 0, 1 | 0 |
| | | | | (k₃, l₀), (k₄, l₀), (k₅, l₀) | | | |
| 10 | 12 | 1 | cdm4- | (k₀, l₀), (k₁, l₀), (k₂, l₀) | 0, 1, 2 | 0, 1 | 0, 1 |
| | | | FD2-TD2 | | | | |
| 11 | 16 | 1, 0.5 | fd-CDM2 | (k₀, l₀), (k₁, l₀), (k₂, l₀), | 0, 1, 2, 3, 4, | 0, 1 | 0 |
| | | | | (k₃, l₀), (k₀, l₀ + 1), (k₁, l₀ + 1), | 5, 6, 7 | | |
| | | | | (k₂, l₀ + 1), (k₃, l₀ + 1) | | | |
| 12 | 16 | 1, 0.5 | cdm4- | (k₀, l₀), (k₁, l₀), (k₂, l₀), (k₃, l₀) | 0, 1, 2, 3 | 0, 1 | 0, 1 |
| | | | FD2-TD2 | | | | |
| 13 | 24 | 1, 0.5 | fd-CDM2 | (k₀, l₀), (k₁, l₀), (k₂, l₀), | 0, 1, 2, 3, 4, | 0, 1 | 0 |
| | | | | (k₀, l₀ + 1), (k₁, l₀ + 1), | 5, 6, 7, 8, 9, | | |
| | | | | (k₂, l₀ + 1), (k₀, l₁), (k₁, l₁), | 10, 11 | | |
| | | | | (k₂, l₁), (k₀, l₁ + 1), (k₁, l₁ + 1), | | | |
| | | | | (k₂, l₁ + 1) | | | |
| 14 | 24 | 1, 0.5 | cdm4- | (k₀, l₀), (k₁, l₀), (k₂, l₀), | 0, 1, 2, 3, 4, 5 | 0, 1 | 0, 1 |
| | | | FD2-TD2 | (k₀, l₁), (k₁, l₁), (k₂, l₁) | | | |
| 15 | 24 | 1, 0.5 | cdm8- | (k₀, l₀), (k₁, l₀), (k₂, l₀) | 0, 1, 2 | 0, 1 | 0, 1, |
| | | | FD2-TD4 | | | | 2, 3 |
| 16 | 32 | 1, 0.5 | fd-CDM2 | (k₀, l₀), (k₁, l₀), (k₂, l₀), | 0, 1, 2, 3, 4, | 0, 1 | 0 |
| | | | | (k₃, l₀), (k₀, l₀ + 1), (k₁, l₀ + 1), | 5, 6, 7, 8, 9, | | |
| | | | | (k₂, l₀ + 1), (k₃, l₀ + 1), (k₀, l₁), | 10, 11, 12, 13, | | |
| | | | | (k₁, l₁), (k₂, l₁), (k₃, l₁), | 14, 15 | | |
| | | | | (k₀, l₁ + 1), (k₁, l₁ + 1), | | | |
| | | | | (k₂, l₁ + 1), (k₃, l₁ + 1) | | | |
| 17 | 32 | 1, 0.5 | cdm4- | (k₀, l₀), (k₁, l₀), (k₂, l₀), | 0, 1, 2, 3, 4, | 0, 1 | 0, 1 |
| | | | FD2-TD2 | (k₃, l₀), (k₀, l₁), (k₁, l₁), | 5, 6, 7 | | |
| | | | | (k₂, l₁), (k₃, l₁) | | | |
| 18 | 32 | 1, 0.5 | cdm8- | (k₀, l₀), (k₁, l₀), (k₂, l₀), (k₃, l₀) | 0, 1, 2, 3 | 0, 1 | 0, 1, |
| | | | FD2-TD4 | | | | 2, 3 |

Accordingly, the CSI-RS in SL may be used for positioning with a configuration of Density=1 with contiguous frequency allocation, Cdm-Type=noCDM, and comb-4 and/or comb-12.

For SL-PRS resource allocation, a specific RS resource pool may be used. In the RS resource pool, only an RS may be transmitted. Herein, the RS resource pool may only include SL-PRS, but other RSs may possibly be transmitted there as well. The RS resource pool may be configured/pre-configured by RRC signaling, and may be defined as a bitmap indicating resources in time, and a set of subchannels.

Since it is preferable for the SL-PRS to occupy the entire bandwidth, the set of subchannels may not be indicated, and instead, the resources in time may be indicated. When the RS resource pool occupies the entire carrier, the RS resource pool may be viewed as a special subframe.

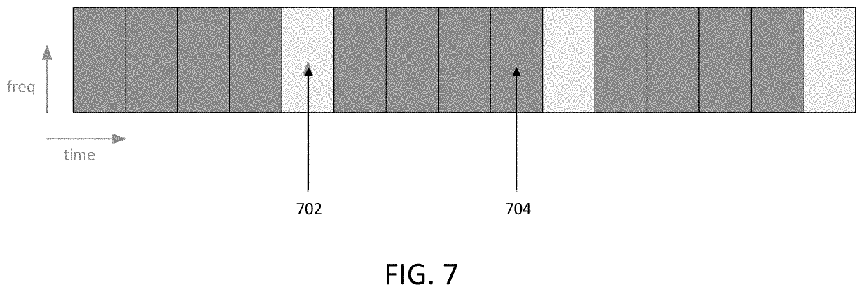

FIG. 7 is a diagram illustrating an RS resource pool when an entire carrier bandwidth is used, according to an embodiment. Specifically, the RS resource pool includes three positioning slots 702 amongst regular slots 704.

When carrier aggregation is used, in order for the SL-PRS to occupy all of the available bandwidth, the RS resource pool slots may be aligned. Thus, when the RS resource pool is configured, the configuration may include a list of carriers that the RS resource pool occupies.

FIG. 8 is a diagram illustrating a slot structure in the RS resource pool, according to an embodiment.

At a high level, the slot structure may be similar to a regular slot. A first symbol 802 is for AGC settings. Subsequent symbols 804 are for PSCCH transmission (which can be overlapped with PSSCH). PRSs may be transmitted within a same zone 806 as PSSCH. A last symbol 808 is a guard time symbol.

The difference between this slot structure and a regular slot structure is that in the symbols following PSCCH, the symbols are used for SL-PRS transmission instead of for PSSCH. The resource allocation for SL-PRS may be different than the resource allocation for PSSCH. For example, there is no subchannel allocation. However, alternate embodiments may allocate subchannels to further multiplex the SL-PRS in frequency. The SL-PRS resources may be indicated by a comb factor, a starting symbol (optional), and an end-symbol (optional), as described herein.

Because the SL-PRSs are allocated in a different manner than the PSSCHs, a new mapping between the PSCCH and the SL-PRS may be required, and a new PSCCH format may be needed.

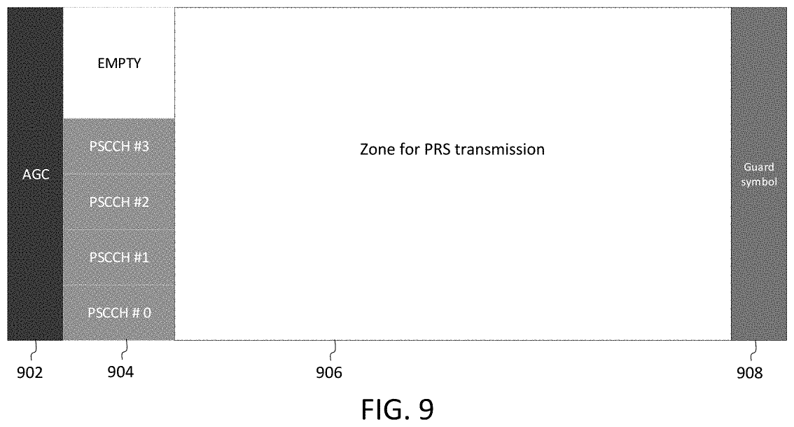

FIG. 9 is a diagram illustrating a slot structure having the PSCCH, according to an embodiment. A first symbol 902 is for AGC settings. Subsequent symbols 904 are for PSCCH transmission. PRSs may be transmitted within a same zone 906 as PSSCH. A last symbol 908 is a guard time symbol.

The PSCCH symbols 904 are split into N resources. Each resource i corresponds to an SL-PRS resource. The PSCCH resource may be a subchannel, a set of PRBs, or a comb.

For example, assuming that an SL-PRS occupies all the available time symbols and that comb-4 is used, a PSCCH resource may be a subchannel occupying the PSCCH symbols. Thus, four PSCCH resources would be defined.

In some cases, an SL-PRS may be made of several resources (e.g., a comb-2 resource may be created by aggregating two comb-4 resources). In such a case, only a single PSCCH resource may be used, and would be the PSCCH resource for, for example, the lowest resource index.

A message sent on the PSCCH resource occupies an SCI. The SCI may be a different format, and possibly size, than an existing first stage SCI. Alternatively, the fields may be remapped. Without loss of generality, a new SCI, SCI format 1-RS, is described. This SCI may include information, such as, for example, the transmitting UE ID, the number of reserved resources, the periodicity of reserved resources, and/or a resource allocation field, as described above. This field may be optional if a UE can only be allocated a single SL-PRS resource since there is a one-to-one correspondence between PSCCH resources and SL-PRS resources. The SCI may also include information, such as, for example, an SL-PRS ID, an SL-PRS resource set ID, and/or an SL-PRS resource ID.

It may also be possible to use a second-stage SCI. In such a case, the second stage SCI would be transmitted on the symbols immediately following the PSCCH. While referred to as a PSCCH, another channel may be defined to allocate the SL-PRS (e.g., RS-PSCCH).

Another alternative for transmitting the SL-PRS across the full bandwidth is to include an indication in the SCI of the presence of SL-PRS, either in this slot or in future slots. This indication may be carried in the first or second stage SCI. Additionally, the SCI may also include an SL-PRS index, which specifies a starting subcarrier for the SL-PRS within a subchannel. In particular, an SL-PRS with comb factor of 4 would allow the multiplexing (i.e., interlacing) of SL-PRS signals from four different UEs, whereby each UE uses the REs indicated by its comb index for transmitting the SL-PRS within the symbols used to carry the SL-PRS transmission. Additionally, a UE may not be allowed to use the remaining REs within the symbol for any other use (e.g., data transmission). In this case, if four UEs share the bandwidth and a comb 4 is configured per resource pool, the UEs may be able to spread their SL-PRS transmissions across the complete bandwidth to improve the accuracy of positioning without interfering with one another.

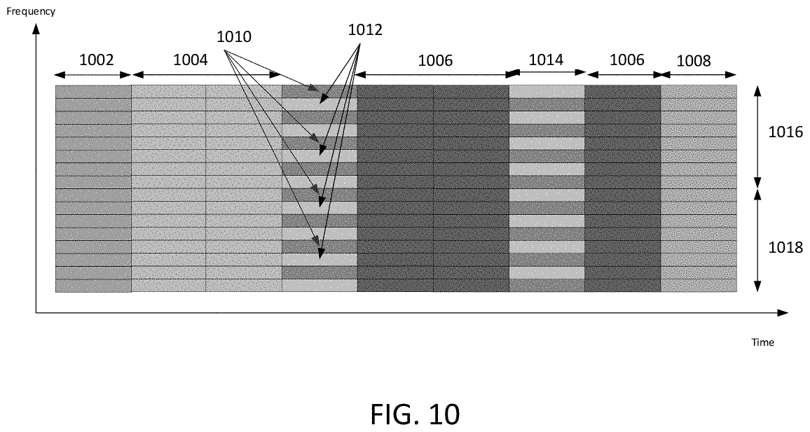

FIG. 10 is a diagram illustrating SL-PRS location with two UEs, according to an embodiment. The configuration of FIG. 10 includes an AGC symbol 1002, PSCCH symbols 1004, PSSCH symbols 1006, and a gap 1008.

In FIG. 10, two UEs are transmitting SL-PRS. First SL-PRSs 1010 are used by a first UE, and second SL-PRSs 1012 are used by a second UE in an SL-PRS symbol 1014. Based on resource pool configuration, there exist only two subchannels, and the SL_PRS transmission may be configured as enabled with comb 2. In this case, each of the two UEs has indicated in the PSCCH a specific SL-PRS index (e.g., UE 1 indicates index 1 and UE 2 indicates index 2). Each UE sends its SL-PRS across the complete band and is not limited to the subchannels over which it is transmitting its data. In this example, each UE is transmitting its SL-PRS over the full band (i.e., first subchannel 1016 and second subchannel 1018).

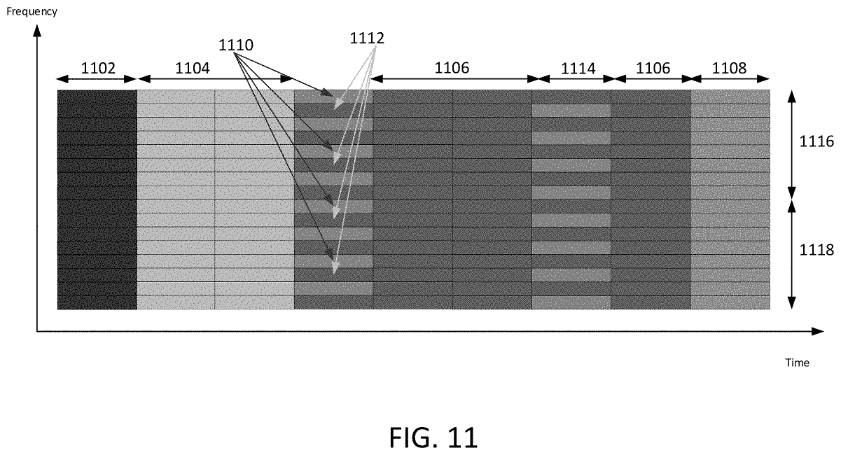

FIG. 11 is a diagram illustrating SL-PRS location with a single UE, according to an embodiment. The configuration of FIG. 11 includes an AGC symbol 1102, PSCCH symbols 1104, PSSCH symbols 1106, and a gap 1108. SL-PRS symbols 1114 include SL-PRS resources 1110 and PSSCH resources 1112 over first subchannel 1116 and second subchannel 1118.

Specifically, in FIG. 11, there exists only a single UE and the UE does not utilize the REs used for the SL-PRS that it did not reserve, but fills the resources corresponding to the SL-PRS index that it indicated in the PSCCH.

If the UE shares the bandwidth with UEs not transmitting SL-PRS, then the latter UEs may have to either not use the symbol or at least puncture the REs already reserved for SL-PRS transmission by neighboring UEs that share the same slot. This reservation may be known from the SCI sent by the neighboring UEs that contain an indication of presence of PRS in future reservations along with the SL-PRS index. The behavior of either discarding the symbol or the REs used for the SL-PRS may be configured per resource pool. Early-release UEs may not be able to access the resource pool where the presence of PRS is indicated.

SL-PRS may only be sent in future reservations so that other neighboring UEs can avoid colliding with the SL-PRSs. Additionally, the reservation may be far enough to fulfil the processing time requirements.

In case a UE excludes future resources based on a half-duplex constraint (i.e., the hypothetical SCI in 510 of FIG. 5), it may also exclude the symbols configured by the resource pool to carry the SL-PRS. Subsequently, 510 of FIG. 5 may also be updated to avoid the PRS locations, so as not to interfere with the PRS sent by neighbors.

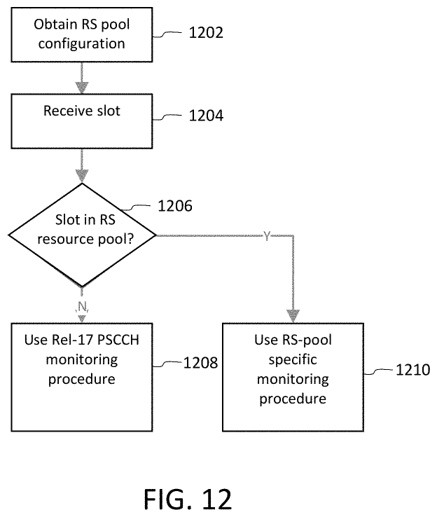

FIG. 12 is a flowchart illustrating a method for the receiving the SL-PRS, according to an embodiment.

At 1202, RS pool configuration may be obtained by the UE. This may be configured/pre-configured by RRC signaling. The RS resource pool configuration is described in detail above. An RRC message indicates, for example, the location of the RS resource pool, what may be transmitted in it, etc.

At 1204, a slot may be received by the UE. The UE attempts to receive a slot on the SL. The UE may first decode the PSCCH.

At 1206, the UE may determine whether the slot is in the RS resource pool. Depending on the determination, a different PSCCH format is used.

If the RS resource pool does not occupy all of the carriers, a portion of the carrier may be used for another resource pool for PSSCH transmission, for example. In such a case, a UE may have to monitor two different PSCCH formats at two different frequency locations. Alternatively, some priority rules may be defined (e.g., the UE may attempt to obtain SL-PRS only, and is not expected to receive a PSSCH in another resource pool).

If the slot is not in the RS resource pool, the 3GPP Rel-17 PSCCH monitoring procedure may be used, at 1208. In such a case, the UE may assume the 3GPP Rel-16/Rel-17 PDSCH allocation in terms of subchannels, and the associated PSCCH mapping is used. The UE may also assume that SCI format 1 A is used, and that a second stage SCI is present.

If the slot is in the RS resource pool, an RS-pool specific PSCCH monitoring procedure may be used, at 1210. In such a case, the UE may assume that the slot structure, the PSCCH to SL-SRS resource mapping, and the SCI format are as described above.

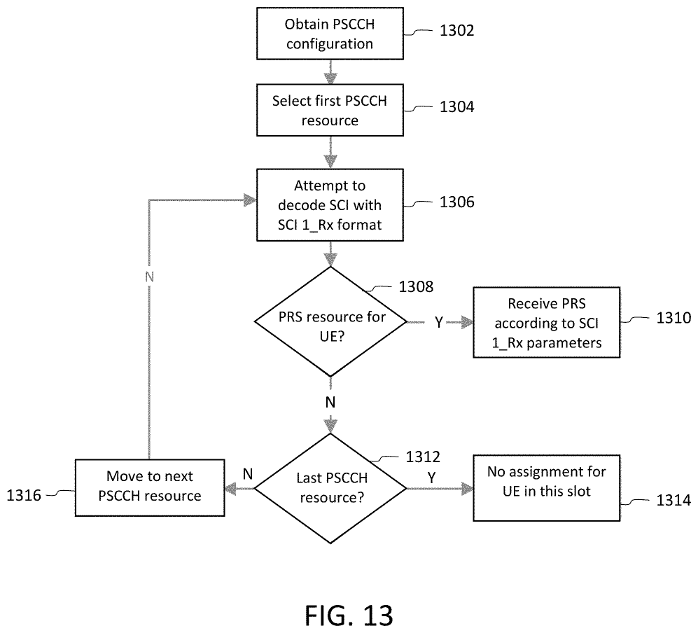

FIG. 13 is a flowchart illustrating a method for receiving the SL-PRS, according to an embodiment.

At 1302, the UE may obtain PSSCH configuration. This operation may be hard coded, pre-configured, or configured (e.g., by RRC signaling). In order to obtain the PSCCH, the UE may need to know the number of time symbols, the number of frequency resources, and/or the size of a resource, etc.

At 1304, the UE may select a first PSCCH resource. The UE may examine all resources from 0 to N-1 (assuming N-1 possible SL-PRS resources) in sequential order. On each resource, the UE may attempt to decode the SCI.

In some cases, there may be a large number of SL-PRS resources, which may put blind decoding constraints on the UE. This may be solved by, for example, having the UE only monitor a limited set of PSCCH candidates (e.g., 50), up to UE implementation, and/or the use of group scheduling, etc.

At 1306, the UE may attempt to decode the SCI. On each PSCCH resource, the UE may blindly attempt to decode an SCI format 1-Rx to determine if there is an assignment.

At 1308, the UE determines whether the PRS resource is for the UE. If the UE has decoded an SCI, it then determines if it is an assignment for the UE.

If the PRS resource is for the UE, the UE may receive PRS according to SCI 1_Rx parameters, at 1310.

If the PRS resource is not for the UE, the UE may determine whether it is a last PSCCH resource, at 1312. If it is a last PSCCH resource, the UE may determine that there is no assignment for the UE in this slot, at 1314. If it is not the last PSCCH resource, the UE moves to a next PSCCH resource, at 1316, and returns to attempt to decode the SCI at 1306.

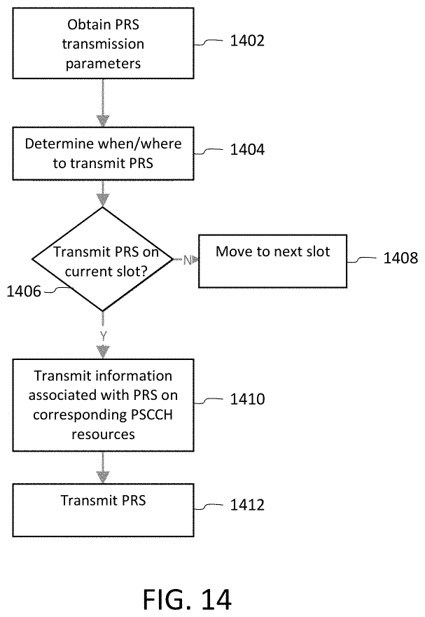

FIG. 14 is a flowchart illustrating a method for transmitting the SL-PRS, according to an embodiment.

At 1402, the UE may obtain the SL-PRS transmission parameters, such as, for example, resource pool information, and/or which comb to use. Parameters other than the pool information may be obtained from another UE (e.g., a UE needing to receive the SL-PRS) through, for example, PC5 RRC. Some parameters may also be pre-configured.

At 1404, the UE may determines when and where to transmit the PRS. The Mode-2 resource selection procedure may be reused on the SL-PRS resource pool. The resource selection window and sensing window may be different than those used for sensing on other resource pools. Other determinations may include randomly selecting a resource.

At 1406, the UE may determine whether to transmit the PRS on the current slot. If the UE determines not transmit the PRS on the current slot, the UE may move to the next slot, at 1408. If the UE determines to transmit the PRS on the current slot, the UE may transmit information associated with the PRS on corresponding PSCCH resources, at 1410, and transmits the PRS, at 1412.

Once the UE has obtained a resource for where to transmit the SL-PRS, it transmits the PSCCH according to the format for the RS pool and the corresponding SL-PRS.

When the RS pool is sparse, reusing the Mode-2 procedure may be problematic in that it increases latency. However, once a resource has been selected, the UE may indicate in a regular SCI (if it has a transmission) that it will transmit the PRS in the next RS pool. This indication may be similar to the CSI-RS indication. The signaling would be slightly different since it needs to indicate that the UE will transmit in a future slot in the RS pool (unlike the CSI-RS, which is transmitted in the slot where the SCI is received). This indication could be either in the first or the second stage SCI.

This may require the UE to transmit an SCI. Up to 3GPP Rel-16, an SCI must be associated with a PSSCH. However, if a standalone SCI transmission is supported in the future, a standalone SCI (i.e., without associated PSSCH) may be used. Additionally, the UE may transmit the PRS reservation only if it already needs to send an SCI. If it does not, the PRS reservation is not transmitted. Further, the UE may transmit dummy data if it does not have data to transmit. Also, given that the PRS transmission generally occurs over several slots, the UE may only send the SCI before sending the first PRS transmission, or when resource reselection for the PRS has occurred.

As described above, a UE may acquire resources to transmit the PRS by using the Mode-2 resource selection procedure on a regular or a special resource pool. The UE may also acquire resources to transmit by randomly selecting a set of resources for transmission in a regular or a special resource pool.

However, to achieve relatively good positioning estimation, a UE may transmit its PRS across the complete bandwidth with minimal interference. This may be done in one slot or by using a comb structure to allow two or more UEs to share the bandwidth and transmit their PRS signals simultaneously. In either case, the transmission of the PRS signals may potentially interfere with other UEs' transmissions (if the puncturing approach discussed above is not considered). Additionally, the UEs that are sending the PRS may attempt to acquire a large bandwidth that might not be possible or can result in significant latency when an opportunity is found, such that either the full bandwidth or at least a large portion of it is empty. To address this, the priority level of the SL PRS may be adjusted to a high level and may be associated with a new set of RSRP thresholds. In particular, two sets of RSRP thresholds may be configured, whereby the first set is used for regular transmissions and the second set is used for PRS transmissions.

This allows the UEs that are transmitting PRS to transmit with less latency by allowing them to pre-empt transmissions of regular UEs and protect them against pre-emption by neighboring UEs.

Additionally, this reduces the chances of collisions with regular UE transmissions, since the newly assigned RSRP thresholds can be set to lower values, and accordingly, prevent other UEs from accessing the resources reserved for PRS transmissions.

In signaling the presence of the PRS to neighboring UEs, a new high priority level may be assigned that can be carried in the first stage SCI to indicate the presence of the PRS. Alternatively, to ensure backward compatibility, a highest priority (i.e., priority 0) may always be used to send the PRS, although there remains a chance of collisions with ultra-reliable low latency communication (URLLC) traffic;

This signaling may also be performed by adding an additional field in the first or second stage SCI, or a new second stage SCI format to indicate the presence of PRSs that may be used to augment the priority field in indicating the highest possible priority.

Accordingly, when the UE determines the subset of resources to be reported to higher layers in SL-PRS resource selection in SL resource allocation Mode-2, the transmission of the UE selecting resources for SL-PRS may have higher priority than other signals/channels for SL communications. This may be achieved by using the highest priority for backward compatibility or by adding a new exclusive priority level for PRS. Additionally, the UE may be configured with different RSRP thresholds for the combinations of priorities for SL-PRS resource allocation (i.e., the introduction of a new IE SL-Thres-PRS-RSRP-List for SL positioning).

In order for the UE to know when to transmit the SL-PRS, the UE may have it on demand. When a UE needs to perform positioning, it may send a request to other UEs to send the SL-PRS. However, it is also possible for the UE to autonomously transmit the SL-PRS without being probed. In such a case, the UE may determine when to transmit the SL-PRS based on pre-configuration or random determination.

With respect to pre-configuration, the UE may be pre-configured to transmit on some slots based on, for example, its UE ID.

With respect to random determination, the UE may randomly transmit on a given RS slot based on a given probability.

The rate of SL-PRS transmission may be determined based on, for example, a code block group (CBG) (or equivalent measurement).

In such a procedure, the UE may indicate its location in the PSCCH associated with the SL-PRS. A receiving UE may then decode the PSCCH, obtain the Tx UE location, and, with the associated SL-PRS, obtain the corresponding SL reference signal time difference (RSTD).

For PRS resource allocation Mode-1, the gNB manages the SL resources. The PRS resources allocation for Uu link positioning may be reused with some modification. The number of available symbols for data and reference signals in SL is 12 for the case without feedback and 9 for the case with feedback. The following changes are required for the PRS resource allocation in SL. The first symbol of the DL PRS within a slot is greater than or equal to 1. For the case without feedback, the size of the SL-PRS resource in the time domain may be {2, 4, 6, 12} and the comb size may be {m2, 4, 6,12}. For the case with feedback, the size of the SL-PRS resource in the time domain may be {2, 4, 6} and the comb size may be {2, 4, 6}.

The SL-PRS configuration may be configured by RRC signaling. The indication for the UE to transmit the SL-PRS may be done by RRC signaling, a new MAC CE, or a new DL control information (DCI) format (DCI format 5-B). This new DCI format indicates when and where to transmit the SL-PRS.

When the SL-PRS is not transmitted in an RS resource pool, it shares the pool with PSSCHs, and possibly other SL-PRSs. In such a case, the SL resource procedure may be mostly reused with some changes. First, the SL-PRS only occupies some REs, but not the entire slot. Second, other unoccupied REs may be used for PSSCH transmission. The SL-PRS needs to occupy the entire carrier.

With respect to the SL-PRS only occupying some REs, when indicating a reservation, the UE needs to signal that it is for SL-PRS only, and that only a limited set of REs is used within a subchannel. This may be done by reusing the existing SCI format 1-A with the following changes. First, one bit (taken from the reserved bits) indicates that the reservation is for an SL-PRS. Second, the existing frequency resource allocation field is interpreted to signal the SL-PRS, as described above.

With respect to other unoccupied REs being used for PSSCH transmission, the Mode-2 SL resource allocation procedure may be slightly modified. One step may be added into the procedure of 3GPP Rel-16 SL resources allocation for Mode-2, shown in FIG. 5, which can insure that the PRS resources occupy the maximum available bandwidth.

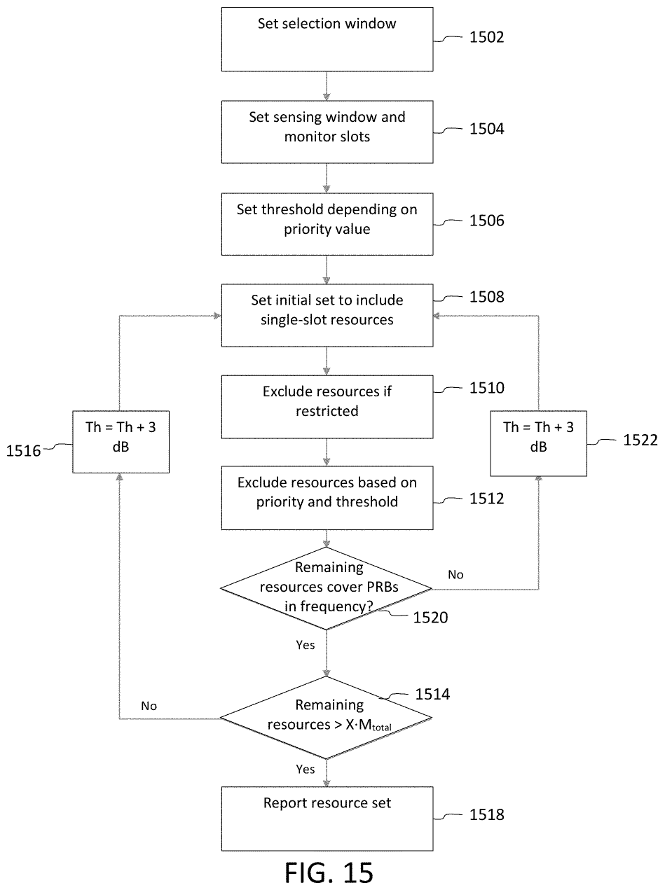

FIG. 15 is a flowchart illustrating a method for resource selection for Mode-2 in SL positioning, according to an embodiment.

At 1502, a selection window may be set, as described above with respect to 502 of FIG. 5.

At 1504, a sensing window may be set and slots may be monitored by decoding PSCCH and measuring RSRP, as described above with respect to 504 of FIG. 5.

At 1506, a threshold may be set depending on the priority value, as described above with respect to 506 of FIG. 5.

At 1508, an initial set SA may be initialized to include all of the candidate single-slot resources, as described above with respect to 508 of FIG. 5.

At 1510, the UE may exclude resources if restricted, as described above with respect to 510 of FIG. 5.

At 1512, the UE may exclude resources if they are occupied by the UE with higher priority and RSRP>Th, as described above with respect to 512 of FIG. 5.

At 1520, the UE determines whether remaining resources can cover all of the PRBs in frequency. If the remaining resources cannot cover all of the PRBs in frequency, Th(pᵢ, pⱼ) may be increased by 3 dB for each priority value Th(pᵢ, pⱼ), at 1522, before returning to set the initial set at 1508.

If the remaining resources can cover all of the PRBs in frequency, the UE determines whether remaining resources in the selection window are greater than X·Mₜₒₜₐₗ, at 1514, as described above with respect to 514 of FIG. 5

If the number of candidate single-slot resources remaining in the set SA is less than or equal to X·Mₜₒₜₐₗ, then Th(pᵢ, pⱼ) may be increased by 3 dB for each priority value Th(pᵢ, pⱼ), at 1516, before returning to set the initial set at 1508, as described above with respect to 516 of FIG. 5.

If the number of candidate single-shot resources remaining in the set S_{A} is greater than X·Mₜₒₜₐₗ, then the UE may report remaining resources of set S_{A} to higher layers, at 1518, and the higher layers may randomly select a candidate resource for transmission, as described above with respect to 518 of FIG. 5.

Accordingly, for SL PRS resource allocation in Mode-2, the reported candidate resource set by UE should cover the entire available bandwidth (i.e., all the sub-channels) for SL positioning.

For SL positioning in FR2, beam sweeping may be necessary during the measurement of PRS. Therefore, at least 2 DL PRS resource sets and/or CSI-RS resource sets may be provided per UE. This enables the two stage beam-sweeping by allowing for one PRS/CSI-RS resource set to be narrow beam and one PRS/CSI-RS resource set to be wide beam. Further, the association information between the PRS/CSI-RS resources are within the two sects (e.g., PRS/CSI-RS resource X and Y from set #2 are nested in PRS/CSI-RS resource Z from set #1). The PRS/CSI-RS resources belonging to the same resource set may have the same time-frequency domain configuration. A new QCL relationship between the PRS/CSI-RS resources in two different PRS/CSI-RS resource sets may be introduced. If one PRS/CSI-RS resource in the first resources set is the QCL source for multiple PRS/CSI-RS resources in the second resource set, then the first PRS/CSI-RS resource set is configured for the wide beams and the second resource set is configured for the narrow beams.

Accordingly, there may be at least two PRS/CSI-RS resource sets for SL positioning. A new QCL relationship may be introduced, in which the UE measures the QCL source PRS/CSI-RS resources in one PRS/CSI-RS resource set for the wide beams and all the corresponding PRS/CSI-RS resources, which are QCL-ed with the source PRS/CSI-RS resources in another PRS/CSI-RS resource set for the narrow beams.

For beam forming in FR2, the beams may be directionally formed at the transmitter and the receiver. The PRS/CSI-RS resources that are occupied by other transmitting UEs may also be utilized without collision if the direction of the transmit/receive beam is different. For Uu link positioning, the Tx beam direction (or the PRS resource ID) may be included in common NR positioning IEs in an LTE positioning protocol (LPP) from the LMF to the UE. For SL positioning, the Tx beam direction (or PRS/CSI-RS resource ID) may be contained in the SCI.

Accordingly, for SL positioning in FR2, the PRS resource ID, which is associated with the spatial transmission filter at the Tx UE, may be included in the SCI (i.e., first stage SCI or second stage SCI).

When transmitting on the SL, the variations in received signal power at the UE in SL may be more significant than on the Uu link. This difference may be due to the fact that the UE can receive a signal from a UE that is very close or very far. This makes the AGC difficult to perform. AGC is a process performed by the receiver to automatically adjust the amplifier gain so that the radio frequency (RF) signal matches the analog-to-digital converter (ADC) dynamic range.

For SL communication, over the course of one slot, the UE may transmit with the same power. The first symbol of the slot may be a repetition of the second symbol. The Rx UE may use this symbol to set up its AGC.

If a dedicated resource pool is used for SL-PRS, the AGC setting might be more difficult. Specifically, on the first symbol(s), the UE receives the first stage SCI, and for the remainder of the slot, the UE receives the SL-PRS. Consequently, the received power on the first symbols may be different than the received power on the other slots.

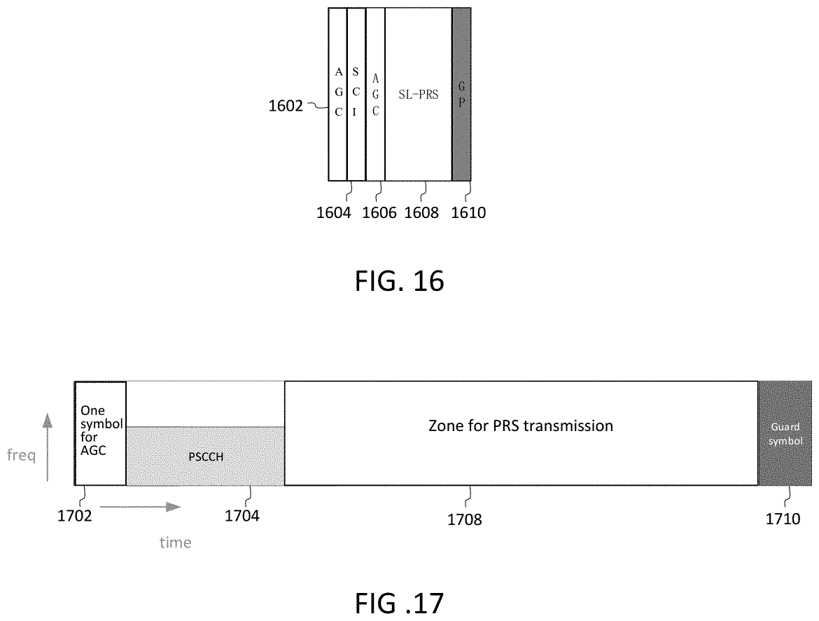

FIG. 16 is a diagram illustrating AGC design for the slot of the SL-PRS, according to an embodiment. An AGC symbol 1602 is duplicated after an SCI symbol 1604, at a first symbol 1606 where transmission of SL-PRS 1608 occurs to re-set the AGC. A guard time symbol 1610 follows the SL-PRS 1608. However, this solution is not optimal, since it may incur additional symbol overhead (i.e., an additional 7% overhead per slot). Therefore, there may be a need to provide a slot structure that enables AGC setting for SL-PRS transmission, without adding an additional symbol for AGC setting.

The SL-PRS may occur in a separate, dedicated resource pool. However, it may be desirable to send the SL-PRS along with data, if, for example, there is already a link established between the two UEs, or to reduce the positioning latency.

When transmitting the SL-PRS along with data, the UE may need to indicate whether the SL-PRS is present or absent. Therefore, there is a need for signaling to indicate whether the SL-PRS is transmitted along with data.

To achieve SL positioning with high accuracy, NR UEs may be capable of sending PRS over a large bandwidth. In order to achieve this, a special resource pool may be relied on in which only PRS signals are transmitted without any data. In particular, in this resource pool, only control signaling (i.e., a PSCCH) and PRS exist. The PSCCH provides the reserved resources over which the PRS signals may be transmitted, and provides the source ID of the NR UE that is transmitting the reference signal.

FIG. 17 is a diagram illustrating an AGC in a slot structure, according to an embodiment. A first symbol 1702 for AGC is before a PSCCH symbol 1704. A zone 1708 to transmit the SL-PRS is a wideband signal that spans the complete bandwidth, whereas the PSCCH symbol 1704 may be limited to one subchannel. A guard time symbol 1710 follows the zone 1708. Thus, the power on the symbols containing the PSCCH is different than on the symbols only containing the SL-PRS. This may be magnified when multiple SL-PRS signals from multiple UEs are multiplexed in a resource pool along with their associated PSCCH to achieve better utilization of the available spectrum.

Without careful design, a UE that transmitted its PSCCH at subchannel X may be required to achieve AGC training for the complete bandwidth for its PRS signals despite the fact that its PSCCH, and its associated AGC symbol at the beginning of the slot, span only one subchannel. This will cause additional overhead.

One way to achieve AGC training for SL-PRS is to reserve one symbol before the SL-PRS symbols for AGC training. The AGC symbol is a repetition of the first SL-PRS symbol, which is an actual starting symbol of useful information. This design for AGC is shown in FIG. 16. However, this design has a large overhead since it introduces two symbols for AGC training in one slot (one for PSCCH and another for SL-PRS). To address this issue, the following two options are proposed to achieve AGC training for SL-PRS.

As a first option for achieving AGC training for SL-PRS, if SL-PRS resource allocation is performed only for a single UE in a slot, then only one symbol at the beginning of the slot is used for AGC training. This symbol is the repetition of the second symbol of the slot.

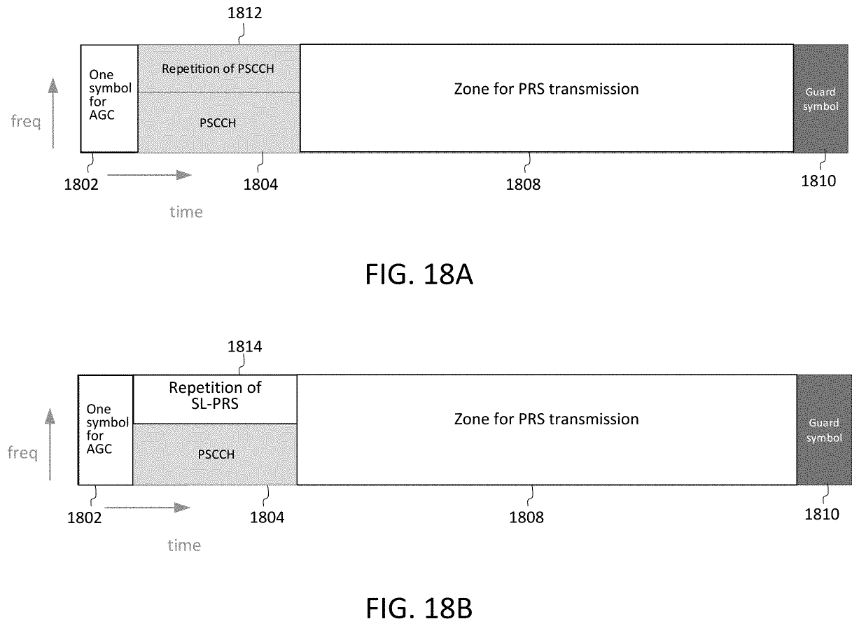

FIG. 18A is a diagram illustrating a slot structure with PSCCH repetition, according to an embodiment. A first symbol 1802 for AGC is before a PSCCH symbol 1804. A zone 1808 to transmit the SL-PRS is a wideband signal that spans the complete bandwidth, whereas the PSCCH symbol 1804 may be limited to one subchannel. A guard time symbol 1810 follows the zone 1808. Given that the PSCCH 1804 only occupies a small bandwidth (i.e., one subchannel), the remaining frequency resources within the same symbols occupied by the PSCCH 1804 are filled by repetitions of PSCCH transmission 1812.

FIG. 18B is a diagram illustrating a slot structure with SL-PRS repetition, according to an embodiment. Given that the PSCCH 1804 only occupies a small bandwidth (i.e., one subchannel), the remaining frequency resources within the same symbols occupied by the PSCCH 1804 are filled by repetition of SL-PRS resources 1814.

The embodiment of FIG. 18A may enhance the reliability of the PSCCH channel since the transmissions may be jointly decoded. The number of repetitions for the PSCCH may be chosen to match the frequency occupation of the corresponding SL-PRS. For example, if a comb-4 factor is used for the SL-PRS, with a single RE every four being occupied, the repetition of the PSCCH must be such that one RE every four is occupied on the PSCCH symbols (i.e., the number of REs occupied by the PSCCH matches that of the SL-PRS). When there are M REs occupied by SL-PRS, and N REs occupied by multiple PSCCH, where M>N, the repetition of the resources of the PSCCHs may be performed as set forth below.

The entire resources of multiple PSCCHs may be repeated by

$$⌊ \frac{M}{N} ⌋$$

times in the frequency domain. The first

$$M - N \cdot ⌊ \frac{M}{N} ⌋$$

REs in the multiple PSCCH resource region may be copied and placed at the empty resource locations in the frequency domain.

This solution may be extended to the case where there are multiple PSCCHs /multiple UEs in the same subframe. If the PSCCHs are interlaced, as described in greater detail below, then it may be easier to achieve the same frequency occupation. If the PSCCHs are not interlaced, they must be repeated in a way that they do not interfere with each other.

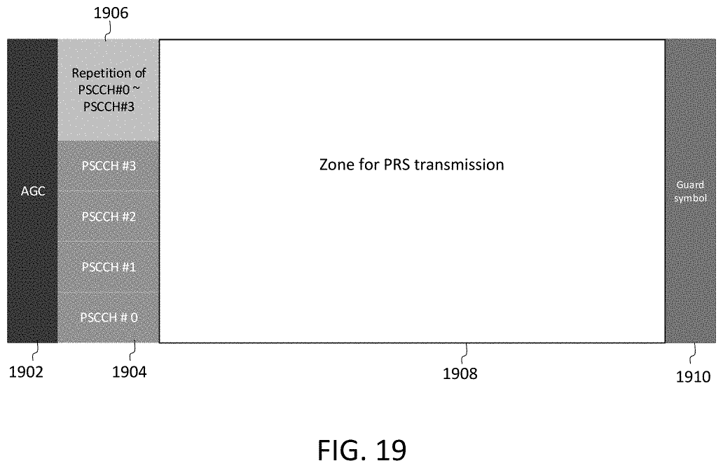

FIG. 19 is a diagram illustrating a slot structure for SL-PRS with multiple PSCCH repetition, according to an embodiment. A first symbol 1902 for AGC is before a PSCCH symbol 1904. A zone 1908 to transmit the SL-PRS is a wideband signal that spans the complete bandwidth. A guard time symbol 1910 follows the zone 1908. The multiple PSCCHs (#0-#3) may be repeated in an frequency division multiplexing (FDM) fashion.

In accordance with a power control mechanism, a UE may determine a power P_{PSCCH}(i) for a PSCCH transmission on a resource pool in PSCCH and SL-PRS transmission occasion i as shown in Equation (5) below:

$${P}_{P S C C H} ( i ) = 10 {log}_{10} ( \frac{{M}_{R E}^{P S C C H} ( i )}{{M}_{R E}^{S L - P R S} ( i )} ) + {P}_{S L - P R S} ( i ) \qquad ( 5 )$$

where P_{SL-PRS}(i) is the power of SL-PRS transmission, M_{RE}^{PSCCH}(i) is a number of resource elements for the PSCCH transmission in PSCCH and SL-PRS transmission occasion i, and M_{RE}^{SL-PRS}(i) is a number of resource elements for PSCCH and SL-PRS transmission occasion i.

As an example of power adjustment for PSCCH and SL-PRS transmission, N REs are occupied on the PSCCH 1902 (e.g., N=4 in FIG. 19), with 2N being the number of REs occupied by the SL-PRS 1908. The UE transmits the PSCCH at 3 dB lower than the power for the SL-PRS transmission. A mapping may be derived identifying where the repetitions are located. In general, when there are M REs occupied by SL-PRS, and N REs occupied by multiple PSCCHs, where M>N, the repetition of the resources of multiple PSCCHs may be performed as set forth below.

The entire resources of multiple PSCCHs may be repeated by

$$⌊ \frac{M}{N} ⌋$$

times in the frequency domain. The first

$$M - N \cdot ⌊ \frac{M}{N} ⌋ REs$$

in the multiple PSCCH resource region may be copied and placed at empty resource locations 1906 in the frequency domain.

As a second option for achieving AGC training for SL-PRS, in the case of UE multiplexing, one symbol at the beginning of the slot may be used for AGC training, and this symbol may be the repetition of the second symbol of the slot (i.e., a repetition of the first symbol carrying the PSCCH). Given that the PRS signals are expected to be staggered in time and to have a special pattern in the frequency domain that covers the complete bandwidth, the PSCCH may also be interlaced such that the bandwidth occupied by the PSCCH matches that of the SL-PRS. In particular, an interlaced PSCCH pattern may be considered to achieve the AGC training for SL-PRS.

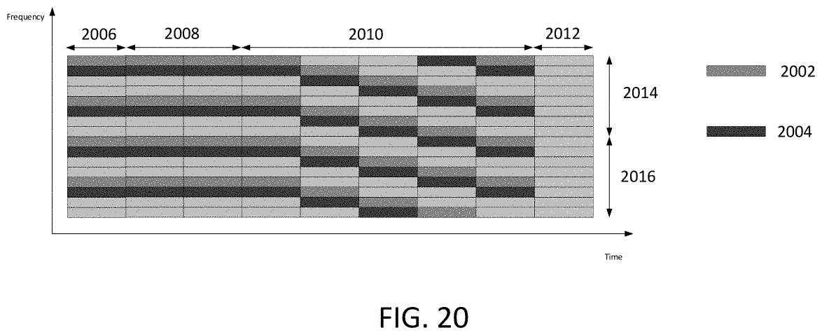

FIG. 20 is a diagram illustrating a slot structure for SL-PRS with PSCCH interlacing, according to an embodiment. First resources 2002 for transmitting PSCCH and SL-PRS for a first UE and second resources 2004 for transmitting PSCCH and SL-PRS for a second UE 2004 may be interlaced with each other in frequency domain, across AGC symbol 2006, PSCCH symbols 2008, and an SL-PRS portion 2010 over a first subchannel 2014 and a second subchannel 2016. A guard time symbol 2012 follows the SL-PRS portion 2010.

Despite the advantages of this approach, in some cases, the bandwidth occupied by the PSCCH may be much smaller than that of the SL-PRS. In this case, the AGC training may not be performed for all subcarriers that would be occupied by the SL-PRS. To address this issue, PSCCH repetitions may be used on top of the interlacing design to match the number of subcarriers occupied by the SL-PRS signals and the corresponding PSCCH.

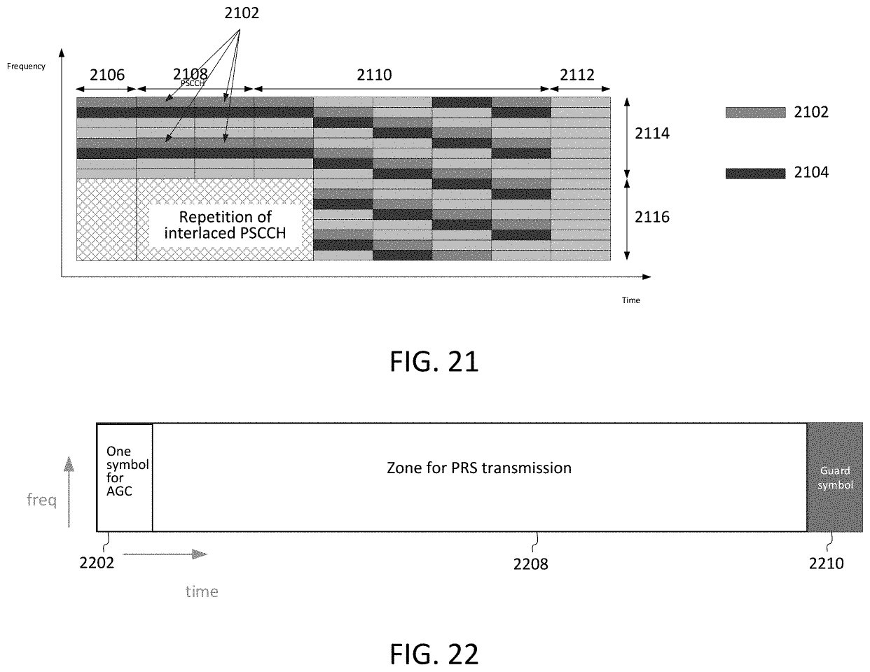

FIG. 21 is a diagram illustrating a slot structure for the SL-PRS with PSCCH interlacing and repetition, according to an embodiment. First resources 2102 for transmitting PSCCH and SL-PRS for a first UE and second resources 2104 for transmitting PSCCH and SL-PRS for a second UE 2104 may be interlaced with each other in frequency domain, across AGC symbol 2106, PSCCH symbols 2108, and an SL-PRS portion 2110 over a first subchannel 2114 and a second subchannel 2116. A guard time symbol 2112 follows the SL-PRS portion 2110.

PSCCH is repeated to match the bandwidth of the SL-PRS. The repeated part of the interlaced PSCCH may not necessarily cover one complete PSCCH. For example, if the SL- PRS has 25 REs while the PSCCH has 10 REs, then the PSCCH will be repeated 2.5 times to achieve the necessary AGC training. In this case, the remaining 0.5 repetition of the PSCCH is not necessarily possible. However, in practice, the interlacing structure of the PSCCH and the SL-PRS patterns may be pre-configured such that the SL-PRS REs are an integer multiple of the PSCCH REs.

PSCCH interlacing for AGC design is advantageous in that transmissions from multiple Tx UEs may be multiplexed in the same slot. There is no need to dedicate an additional symbol for AGC training at the beginning of the SL-PRS since the PSCCH transmission occurs on the same subcarriers used to transmit the PSCCH. 1-1 mapping exists between the PSCCH interlacing index and the corresponding SL-PRS pattern.

In another approach, instead of repeating the interlaced PSCCH, the transmission power of the PSCCH may be adjusted based on the ratio between the PSCCH and SL-PRS REs

$$( \frac{{M}_{R E}^{P S C C H} ( i )}{{M}_{R E}^{S L - P R S} ( i )} )$$

to maintain the same energy per symbol. In this case, the AGC may still be trained without repeating the PSCCH. The interlacing of the PSCCH and the SL-PRS will be different. For example, if the ratio

$$( \frac{{M}_{R E}^{P S C C H} ( i )}{{M}_{R E}^{S L - P R S} ( i )} = 0.5 )$$

then the PSCCH may have a comb 8 structure, whereas the SL-PRS have a comb 4 structure.

In another SL-PRS resource pool configuration, the SCI (i.e., the PSCCH) and the SL-PRS may not be in the same slot. In this case, AGC training is still needed. One approach is captured in FIG. 21, in which one symbol before the SL-PRS symbols for AGC training and one symbol after SL-PRS symbols for Tx/Rx switching in the slot. The SCI may be in one slot and schedules the resources for SL-PRS in a different slot (the SCI may also be sent in a different subchannel or even a different carrier in case of carrier aggregation).

FIG. 22 is a diagram illustrating a slot structure without SCI, according to an embodiment. A first symbol 2202 for AGC is before a zone for SL-PRS transmission 2208. A guard time symbol 2210 follows the zone 2208. In this case, a resource allocation 2208 for SL-PRS may be configured through the assistance data for SL positioning. When the UE is in Mode-1, it may be configured with an SL-PRS ID, each of which is defined such that it could be associated with multiple SL-PRS resource sets. The UE may expect that one of these SL-PRS IDs along with an SL-PRS-ResourceSetID and an SL-PRS-ResourceID may be used to uniquely identify an SL PRS resource. When the UE is in Mode-2, it may reuse the previous configuration or the default configuration of the SL-PRS ID for the UE. To avoid the collision between multiple UEs on the SL-PRS transmission, there is a 1:1 mapping between SL-PRS ID and each UE within a certain distance range. For example, within a geographic zone, each UE is configured to be associated with a unique SL-PRS ID and there is no collision even when multiple UEs transmit SL-PRS simultaneously.

In multiplexing SL-PRS with data, the PSCCH symbols are split into N resources. Each resource i corresponds to an SL-PRS resource. The PSCCH resource may be a subchannel, a set of PRBs, or an interlacing index.

For example, an SL-PRS may occupy all available time symbols, and comb-4 may be used. A PSCCH resource may be a subchannel occupying the PSCCH symbols with 4 interlacing indices, thereby allowing the multiplexing of 4 PSCCH transmissions in the same slot.

Although the SL-PRSs may be transmitted in a dedicated resource pool to reduce complexity, in some cases, it may be preferable to have the data and the SL-PRS jointly transmitted to achieve a better resource utilization.

An alternative for transmitting the SL-PRS across the full bandwidth is to include an indication in the SCI of the presence of SL-PRS either in this slot or in future slots (i.e., a future reservation), and then send the SL-PRS in the REs configured to carry RS within the slot and the subchannels indicated by the SCI. The indication of the presence of the SL-PRS either in this slot or subsequently reserved slots may be carried either in the first or second stage SCI. The indication may be carried in a dedicated field for SL-PRS (e.g., adding one bit to indicate the presence of SL-PRS either in current or future slots) or it may share the same field of the SL CSI request based on pre-configuration. In particular, RRC configuration may be used to indicate whether the CSI-RS or the SL-PRS will be indicated by the CSI-RS 1-bit field currently present in the second stage SCI in 3GPP Rel-16 (i.e., the “CSI request” 1-bit field). This configuration may also be done such that in some slots only CSI-RS may be triggered (e.g., odd slots) and in other slots (e.g., even slots) SL-PRS may be indicated by the CSI-RS 1-bit field in the second stage SCI. This RRC configuration may be performed per resource pool or per UE. In addition, this configuration may be performed such that both CSI-RS and SL-PRS may be triggered by the same bit field. In this case, an Rx UE may rely on other conditions when deciding whether to consider this field as a CSI request or an indication of the presence of SL-PRS. For example, if an Rx UE sent a request for PRSs then it may assume that an upcoming CSI field will be used for SL-PRS indication. The indication of an SL-PRS request may, for example, be carried in the first or second stage SCI and either implicitly (i.e., by setting one or more fields to predefined values) or explicitly (i.e., by adding a new field). These requests may only be allowed if the resource pool is configured to allow SL-PRS transmissions.

Additionally, the resource pool may be configured to allow multiple SL-PRS indices and the SL-PRS may be allowed to span the complete bandwidth by resource pool configuration in specific slots. These configured SL-PRS indices are important in cases in which the SL-PRSs are wideband and can span beyond the subchannels reserved by the SCI. In particular, the resource pool may be configured by any of the following approaches.

In a first approach, the SL-PRS may exist only within the subchannels that are indicated by a frequency resource indication value (FRIV) field in the SCI. In this case, there is a need only for an indication of the presence of SL-PRS, but no SL-PRS index. The SL-PRS may be very similar to the CSI-RS in the sense that they occupy the same resources.

In a second approach, the SL-PRS are wideband and may exist across the complete bandwidth in specific slots. In this case, an indication is needed of the presence of SL-PRS, and an SL-PRS index is also needed such that the SL-PRS of multiple UEs may be multiplexed. For example, one UE may indicate the SL-PRS index 1, whereas a second UE may indicate an SL-PRS index 2.

The SCI (i.e., the first or second stage SCI) may also include the SL-PRS index along with the SL-PRS presence indication (this indication may also be performed implicitly by setting one or more fields to pre-defined values). For example, setting the time resource indication value (TRIV) field to a specific value may be used to indicate the presence of the SL-PRS and the selected SL-PRS index. This reuse of SCI fields may also be limited to resource pools (or slots). SL-PRS is configured and when the SL-PRS are indicated as present.

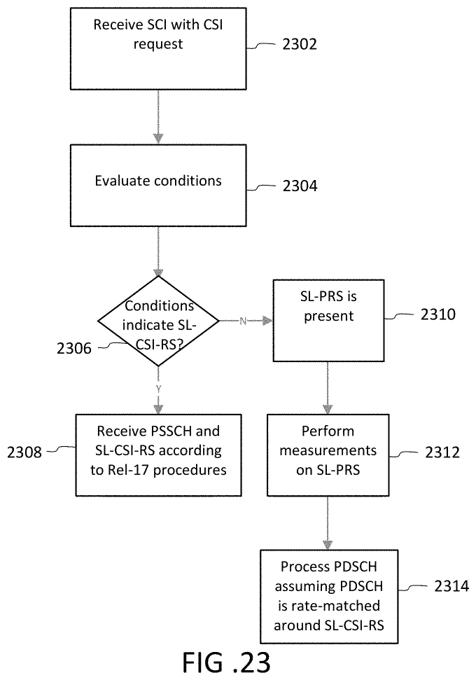

FIG. 23 is a flowchart illustrating reception of SL-PRS multiplexed with data, according to an embodiment. At 2302, the UE may receive an SCI with a CSI request. At 2304, the UE may evaluate conditions. At 2306, the UE may determine whether the conditions indicate SL-CSI-RS. If the conditions indicate SL-CSI-RS, the UE may receive PSSCH and SL-SCI-RS according to 3GPP Rel-16 procedures, at 2308.

If the conditions do not indicate SL-CSI-RS, the UE may determine that SL-PRS is present, at 2310. The UE may perform measurements on the SL-PRS, at 2312, and process PDSCH assuming that the PDSCH is rate-matched around SL-CSI-RS, at 2314.

Further, the SL-PRS may be configured through PC5 RRC, and detailed IEs are listed as set forth below.

| | |
|---|---|
| SL-PRS-Config::= | SEQUENCE { |
| sl-PRS-FreqAllocation | CHOICE { |
| sl-OneAntennaPort | BIT STRING (SIZE (12)), |
| sl-TwoAntennaPort | BIT STRING (SIZE (6)) |
| } | |
| OPTIONAL, -- Need M | |
| sl-PRS-FirstSymbol | INTEGER (3..12) OPTIONAL, |
| -- Need M | |
| ... | |
| } | |

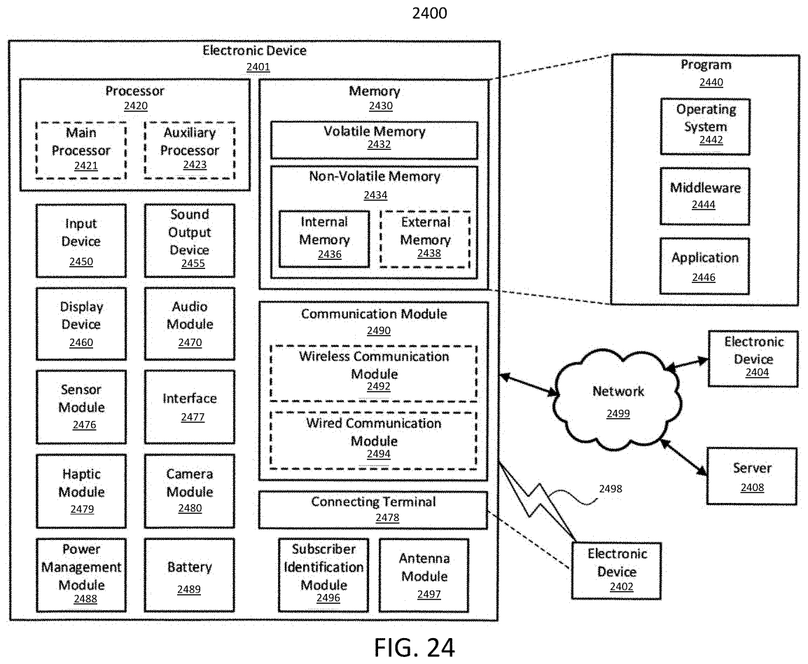

Referring to FIG. 24, an electronic device 2401 in a network environment 2400 may communicate with an electronic device 2402 via a first network 2498 (e.g., a short-range wireless communication network), or an electronic device 2404 or a server 2408 via a second network 2499 (e.g., a long-range wireless communication network). The electronic device 2401 may communicate with the electronic device 2404 via the server 2408. The electronic device 2401 may be embodied as the transmitting or receiving UE described above, and is in communication with the electronic device 2404 or the server 2408, which may be embodied as the gNB or corresponding UE.

The electronic device 2401 may include a processor 2420, a memory 2430, an input device 2440, a sound output device 2455, a display device 2460, an audio module 2470, a sensor module 2476, an interface 2477, a haptic module 2479, a camera module 2480, a power management module 2488, a battery 2489, a communication module 2490, a subscriber identification module (SIM) card 2496, or an antenna module 2494. In one embodiment, at least one (e.g., the display device 2460 or the camera module 2480) of the components may be omitted from the electronic device 2401, or one or more other components may be added to the electronic device 2401. Some of the components may be implemented as a single integrated circuit (IC). For example, the sensor module 2476 (e.g., a fingerprint sensor, an iris sensor, or an illuminance sensor) may be embedded in the display device 2460 (e.g., a display).

The processor 2420 may execute software (e.g., a program 2440) to control at least one other component (e.g., a hardware or a software component) of the electronic device 2401 coupled with the processor 2420 and may perform various data processing or computations.

As at least part of the data processing or computations, the processor 2420 may load a command or data received from another component (e.g., the sensor module 2446 or the communication module 2490) in volatile memory 2432, process the command or the data stored in the volatile memory 2432, and store resulting data in non-volatile memory 2434. The processor 2420 may include a main processor 2421 (e.g., a central processing unit (CPU) or an application processor (AP)), and an auxiliary processor 2423 (e.g., a graphics processing unit (GPU), an image signal processor (ISP), a sensor hub processor, or a communication processor (CP)) that is operable independently from, or in conjunction with, the main processor 2421. Additionally or alternatively, the auxiliary processor 2423 may be adapted to consume less power than the main processor 2421, or execute a particular function. The auxiliary processor 2423 may be implemented as being separate from, or a part of, the main processor 2421.

The auxiliary processor 2423 may control at least some of the functions or states related to at least one component (e.g., the display device 2460, the sensor module 2476, or the communication module 2490 ) among the components of the electronic device 2401, instead of the main processor 2421 while the main processor 2421 is in an inactive (e.g., sleep) state, or together with the main processor 2421 while the main processor 2421 is in an active state (e.g., executing an application). The auxiliary processor 2423 (e.g., an image signal processor or a communication processor) may be implemented as part of another component (e.g., the camera module 2480 or the communication module 2490) functionally related to the auxiliary processor 2423.

The memory 2430 may store various data used by at least one component (e.g., the processor 2420 or the sensor module 2476) of the electronic device 2401. The various data may include, for example, software (e.g., the program 2440) and input data or output data for a command related thereto. The memory 2430 may include the volatile memory 2432 or the non-volatile memory 2434.

The program 2440 may be stored in the memory 2430 as software, and may include, for example, an operating system (OS) 2442, middleware 2444, or an application 2446.

The input device 2450 may receive a command or data to be used by another component (e.g., the processor 2420) of the electronic device 2401, from the outside (e.g., a user) of the electronic device 2401. The input device 2450 may include, for example, a microphone, a mouse, or a keyboard.

The sound output device 2455 may output sound signals to the outside of the electronic device 2401. The sound output device 2455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 2460 may visually provide information to the outside (e.g., a user) of the electronic device 2401. The display device 2460 may include, for example, a display, a hologram device, or a projector and control circuitry to control a corresponding one of the display, hologram device, and projector. The display device 2460 may include touch circuitry adapted to detect a touch, or sensor circuitry (e.g., a pressure sensor) adapted to measure the intensity of force incurred by the touch.

The audio module 2470 may convert a sound into an electrical signal and vice versa. The audio module 2470 may obtain the sound via the input device 2450 or output the sound via the sound output device 2455 or a headphone of an external electronic device 2402 directly (e.g., wired) or wirelessly coupled with the electronic device 2401.

The sensor module 2476 may detect an operational state (e.g., power or temperature) of the electronic device 2401 or an environmental state (e.g., a state of a user) external to the electronic device 2401, and then generate an electrical signal or data value corresponding to the detected state. The sensor module 2476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2477 may support one or more specified protocols to be used for the electronic device 2401 to be coupled with the external electronic device 2402 directly (e.g., wired) or wirelessly. The interface 2477 may include, for example, a high- definition multimedia interface (HDMI), a universal serial bus (USB) interface, a secure digital (SD) card interface, or an audio interface.

A connecting terminal 2478 may include a connector via which the electronic device 2401 may be physically connected with the external electronic device 2402. The connecting terminal 2478 may include, for example, an HDMI connector, a USB connector, an SD card connector, or an audio connector (e.g., a headphone connector).

The haptic module 2479 may convert an electrical signal into a mechanical stimulus (e.g., a vibration or a movement) or an electrical stimulus which may be recognized by a user via tactile sensation or kinesthetic sensation. The haptic module 2479 may include, for example, a motor, a piezoelectric element, or an electrical stimulator.

The camera module 2480 may capture a still image or moving images. The camera module 2480 may include one or more lenses, image sensors, image signal processors, or flashes. The power management module 2488 may manage power supplied to the electronic device 2401. The power management module 2488 may be implemented as at least part of, for example, a power management integrated circuit (PMIC).

The battery 2489 may supply power to at least one component of the electronic device 2401. The battery 2489 may include, for example, a primary cell which is not rechargeable, a secondary cell which is rechargeable, or a fuel cell.

The communication module 2490 may support establishing a direct (e.g., wired) communication channel or a wireless communication channel between the electronic device 2401 and the external electronic device (e.g., the electronic device 2402, the electronic device 2404, or the server 2408) and performing communication via the established communication channel. The communication module 2490 may include one or more communication processors that are operable independently from the processor 2420 (e.g., the AP) and supports a direct (e.g., wired) communication or a wireless communication. The communication module 2490 may include a wireless communication module 2492 (e.g., a cellular communication module, a short-range wireless communication module, or a global navigation satellite system (GNSS) communication module) or a wired communication module 2494 (e.g., a local area network (LAN) communication module or a power line communication (PLC) module). A corresponding one of these communication modules may communicate with the external electronic device via the first network 2498 (e.g., a short-range communication network, such as Bluetooth™, wireless-fidelity (Wi-Fi) direct, or a standard of the Infrared Data Association (IrDA)) or the second network 2499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 2492 may identify and authenticate the electronic device 2401 in a communication network, such as the first network 2498 or the second network 2499, using subscriber information (e.g., international mobile subscriber identity (IMSI)) stored in the subscriber identification module 2496.

The antenna module 2497 may transmit or receive a signal or power to or from the outside (e.g., the external electronic device) of the electronic device 2401. The antenna module 2497 may include one or more antennas, and, therefrom, at least one antenna appropriate for a communication scheme used in the communication network, such as the first network 2498 or the second network 2499, may be selected, for example, by the communication module 2490 (e.g., the wireless communication module 2492). The signal or the power may then be transmitted or received between the communication module 2490 and the external electronic device via the selected at least one antenna.

Commands or data may be transmitted or received between the electronic device 2401 and the external electronic device 2404 via the server 2408 coupled with the second network 2499. Each of the electronic devices 2402 and 2404 may be a device of a same type as, or a different type, from the electronic device 2401. All or some of operations to be executed at the electronic device 2401 may be executed at one or more of the external electronic devices 2402, 2404, or 2408. For example, if the electronic device 2401 should perform a function or a service automatically, or in response to a request from a user or another device, the electronic device 2401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 2401. The electronic device 2401 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
determining, by a user equipment (UE), a resource pool for reception of a sidelink (SL)-positioning reference signal (PRS);
receiving a slot at the UE;
determining, by the UE, whether the slot comprises resources in the resource pool for the SL-PRS; and
decoding, by the UE, SL control information (SCI) of the slot using a first format for the SL-PRS, in case that the slot comprises the resources in the resource pool.

2. The method of claim 1, further comprising decoding, by the UE, the SCI using a second format for a physical SL shared channel (PSSCH), in case that the slot does not comprise the resources in the resource pool.

3. The method of claim 1, wherein the resource pool is configured or preconfigured via radio resource control (RRC) signaling.

4. The method of claim 1, wherein decoding the SCI using the first format indicates time and frequency resource allocation information of the SL-PRS including an SL-PRS resource element offset and a comb size in a frequency domain, and a starting symbol of the SL-PRS and a symbol length in a time domain.

5. The method of claim 1, wherein the SCI is in a physical SL control channel (PSCCH) portion of the slot, and the PSCCH portion occupies a first two symbols or a first three symbols of the slot.

6. The method of claim 5, wherein a portion of the SCI is in an SL-PRS portion of the slot, and symbols containing the portion of the SCI are multiplexed with SL-PRS symbols in time.

7. The method of claim 5, wherein the PSCCH portion is repeated in a frequency domain of the slot.

8. The method of claim 7, wherein a transmission power for a symbol containing the PSCCH portion and repetition of the PSCCH portion is equal to that of other symbols in the slot.

9. The method of claim 1, wherein a first symbol at a beginning of the slot is for automatic gain control (AGC) training for the SL-PRS, and the first symbol is a repetition of a first SL-PRS symbol or a repetition of a first PSCCH symbol.

10. The method of claim 1, wherein the resources of the slot are shared by a plurality of UEs.

11. A method comprising:
determining, by a user equipment (UE), a resource pool for reception of a sidelink (SL)-positioning reference signal (PRS); and
receiving, at the UE, a positioning slot comprising resources in the resource pool;
wherein the positioning slot comprises:
first resources of one more symbols for a physical SL control channel (PSCCH) transmission spanning first subcarriers of the positioning slot; and
second resources for the SL-PRS in a zone of the positioning slot that corresponds to physical SL shared channel (PSSCH) resources in a non-positioning slot, wherein the second resources span a bandwidth of the positioning slot.

12. The method of claim 11, wherein the positioning slot further comprises third resources of the one or more symbols for a repetition of the PSCCH transmission and spanning second subcarriers of the positioning slot, wherein a combination of the first subcarriers and the second subcarriers spans the bandwidth of the positioning slot.

13. The method of claim 12, wherein a first transmission power for a first symbol containing the SL-PRS matches a second transmission power of a second symbol containing the PSCCH transmission and the repetition of the PSCCH transmission.

14. The method of claim 11, wherein a symbol at a beginning of the positioning slot is for automatic gain control (AGC) training for the SL-PRS, and the symbol is a repetition of a first SL-PRS symbol or a repetition of a first PSCCH symbol.

15. The method of claim 11, wherein the positioning slot further comprises a guard time symbol following the second resources for the SL-PRS.

16. The method of claim 11, wherein the PSCCH transmission comprises SL control information (SCI) associated with the SL-PRS.

17. The method of claim 16, wherein the SCI indicates resource allocation information of the SL-PRS in the positioning slot.

18. The method of claim 16, wherein the positioning slot further comprises fourth resources carrying a portion of the SCI not included in the PSCCH transmission.

19. The method of claim 11, wherein resources of the positioning slot are shared by a plurality of UEs.

20. A user equipment (UE) comprising:
a processor; and
a non-transitory computer readable storage medium storing instructions that, when executed, cause the processor to:
determine a resource pool for reception of a sidelink (SL)-positioning reference signal (PRS);
receive a slot;
determine whether the slot comprises resources in the resource pool for the SL-PRS; and
decode SL control information (SCI) of the slot using a first format for SL-PRS, in case that the slot comprises the resources in the resource pool.
